(19) United States
(12) Patent Application Publication
(10) Pub. No.: US 2008/0033882 A1
(43) Pub. Date: Feb. 7, 2008

(54) System and method for on-site electronic software distribution

(75) Inventors: George Kafkarkou, Huntington, NY (US); Christopher G. Hickey, St. James, NY (US)

Correspondence Address: PILLSBURY WINTHROP SHAW PITTMAN, LLP, P.O. BOX 10500, MCLEAN, VA, 22102, US

(73) Assignee: Computer Associates Think, Inc., Islandia, NY (US)

(21) Appl. No.: 11/519,768

(22) Filed: Sep. 13, 2006

Related U.S. Application Data
(60) Provisional application No. 60/834,494, filed on Aug. 1, 2006.

(51) Int. Cl. G06Q 99/00

(52) U.S. Cl. 705/52

(57) ABSTRACT

The invention provides a system and method for electronic distribution of software products via a technician-enabled on-site electronic distribution model that includes a vendor, an electronic distribution system operated by the vendor, one or more resellers, one or more technicians, and one or more end-users. A reseller and a technician associated with the reseller are registered to the electronic distribution system. During an onsite visit to with an end-user, the technician uses the end-user's computer system to access the electronic distribution system and download one or more software products to the end-users computer system. The reseller/technician and the end-user handle the financial transactions involving delivery of the downloaded products to the end-user, while the vendor charges the reseller for the software products downloaded from the electronic distribution system.

### REFERENCE TO RELATED APPLICATIONS

This application claims priority to U.S. Provisional Application No. 60/834,494, filed Aug. 1, 2006, which is hereby incorporated by reference herein in its entirety.

### FIELD OF THE INVENTION

The invention relates to a system and method for distribution of software products via a technician-enabled on-site electronic distribution model.

### BACKGROUND OF THE INVENTION

In some markets, commercial distribution of software products can be cumbersome for organizations that produce or cultivate widely used software products. For example, in some instances, a software product may ultimately be purchased and used by millions of end-users. While this prospect ultimately means high sales figures, efficient and profit-maximizing distribution to these end-users can be difficult.

Accordingly, some software product distribution models include a middleman or re-seller that is introduced into the stream of commerce between the software producing organization (i.e., the vendor) and the end-user. In some instances, resellers may handle their financial relationships with the vendor by establishing a line of credit with the vendor. For widely marketed products, there may be hundreds of thousands of resellers to deal with. As such, the vendor must then manage hundreds of thousands of credit lines, which can also be cumbersome.

As a result of these distribution difficulties, some software distribution models include additional middlemen, sometimes known as “distributors.” These distributors operate between the vendor and the reseller, so that the number of parties transacting directly with the vendors is reduced. Therefore, in some instances, the distribution model includes the following: vendor to distributor; distributor to reseller; reseller to end-user. This type of distribution model is sometimes called a “two-tiered” distribution model.

The advent of electronic commerce has greatly enhanced the ability of organizations to sell and distribute products, including software. However, current software distribution models, including the two-tiered distribution model or similar models, still do not realize many of the benefits that can be provided by modern electronic commerce avenues.

Additionally, in recent years the frequency and necessity of personal contact between end-users, whether they be households or businesses, and skilled computer technicians has increased. For example, a computer technician may be dispatched to a private residence to help diagnose problems with the household computer, to install new equipment, or for other reasons. Similar situations relating to business enterprises may also arise. Nonetheless, this “on site” contact between technicians and end-users has yet to be fully realized as an avenue for sales and distribution of software products. Other problems also exist.

As such, there exists a need for a method and system for electronic software distribution that takes advantage of the personal interaction and sales opportunities presented by on-site contact between computer technicians and end-users. Additionally, this electronic distribution model may, in some embodiments, solve problems related to traditional two-tiered distribution models. This electronic distribution model may also, in some embodiments, bypass one or more of the traditional nodes in the traditional two-tiered distribution model and/or solve other problems in the art.

### SUMMARY OF THE INVENTION

The invention solving these and other problems in the art relates to a system and method for electronic distribution of software products via a technician-enabled on-site electronic distribution model. The on-site electronic distribution model of the invention enables completely inventory-less distribution of software products to end-users by on-site technicians. An on-site technician can perform all the functions necessary to provide end-users with a myriad of software needs without carrying any tools, products, or other equipment to on-site interactions (e.g., “house calls”) with an end-user. The inventory-less distribution provided by the on-site distribution model streamlines and simplifies the technician's operational model and his or her interactions with the end-user during on-site visits. This leads to operational efficiencies for the technician, his or her associated reseller, which ultimately benefits the vendor in the form of higher sales, greater efficiency, or provides other benefits.

Furthermore, whereas other software distribution models involve the sale of a software product at a separate location (e.g., on-line, at a brick-and-mortar location) and may involve installation on-site, the on-site distribution model enables resellers to transact sales on-site and install software products instantly, without previous interaction with end-users regarding sale of the software product.

The invention provides an on-site electronic distribution model whereby one or more software products may be distributed to an end-user via a technician-enabled electronic software distribution system (hereinafter “electronic distribution system”). The on-site electronic distribution model includes an electronic distribution system, a vendor, a reseller, one or more technicians, one or more end-users (each end-user having an end-user computer system), a network, and other elements.

The electronic distribution system may be operated or supported by the vendor. In one embodiment, the vendor may include an organization that produces, develops, or otherwise procures software products and distributes those products for ultimate use by one or more end-users. In some embodiments, part or all of the electronic distribution system may be operated or supported by a third party on behalf of, in partnership with, or otherwise in association with the vendor.

In one embodiment, the on-site electronic distribution model may include one or more resellers. A reseller may include a corporation, partnership, sole proprietorship, or other business organization, entity, or individual that agrees to distribute the vendor's software products via the electronic distribution system using one or more technicians. In some embodiments, the reseller may also engage in other business. For example, the reseller may engage in on-site computer installation/repair for individuals or businesses. Once the reseller registers the with electronic distribution system, the reseller may utilize on-site interaction with customers as opportunities for distribution of the vendor's software products via the electronic distribution system.

The reseller may be associated with one or more technicians. In one embodiment, a technician may be an employee of the reseller, an independent contractor to the reseller, or otherwise be associated with the reseller. In one example, the reseller may have multiple employees, some of which are trained computer technicians that travel to a customer's place of business to perform a service and/or sell one or more products. The reseller may utilize these trained computer technicians to distribute the vendor's software products via the electronic distribution system.

The on-site electronic distribution model may also include one or more end-users. In one embodiment, the end-users may include one or more individuals; a household; a small, medium, or large business organization; a non-profit organization; an educational organization; a religious institution; or other types of end-users.

Each end-user may be associated with an end-user computer system. An end-user computer system may include one or more computers and other computer-related equipment such as, for example, one or more servers, desktop computers, laptops, personal digital assistants, handheld computing devices (e.g., a Blackberry™ device), mobile phones, pagers, computer networks, network-related equipment (e.g., routers), or other equipment.

For example, in one instance, an end-user may comprise an individual. This individual's end-user computer system may comprise a single desktop computer. In another instance, an end-user may include a household. This household's end-user computer system may comprise multiple computers (e.g., two desktop computers and a laptop). In yet another instance, an end-user may include a small business. This small business' end-user computer system may comprise a computer network having one or more servers, multiple desktop computers, multiple laptop computers, multiple handheld computing devices, multiple cell phones, and/or other elements. Other types of end-users may exist having end-user computer systems comprising other components.

In one embodiment, the on-site electronic distribution model may include a network. The network may enable communication and data transfer between the components of the on-site electronic distribution model such as, for example, the electronic distribution system, the vendor, the reseller (via a computer system associated therewith), the technicians (via computer systems associated therewith), the end-users (via their end-user computer systems), the end-user computer systems themselves, and/or other parts of the on-site electronic distribution model.

In one embodiment, the electronic distribution system may include a vendor computer system. The vendor computer system may comprise one or more servers, desktop computers, laptop computers, or other machines with memory and processing capability necessary to store and/or distribute one or more software products, provide access to the electronic distribution system, or provide other features or functions of the invention.

In one embodiment, the electronic distribution system may include one or more portals. The one or more portals may provide resellers, technicians, administrators, or other users with access to the electronic distribution system. In one embodiment, one or more of the one or more portals may comprise one or more websites supported by the vendor computer system or other parts of the electronic distribution system. These one or more websites may provide graphical user interfaces (GUIs) enabling parties operating within the on-site electronic distribution model to perform activities according to the features and functions of the invention described herein.

In one embodiment, the electronic distribution system may also include one or more modules. The one or more modules may include one or more software modules that enable the various features or functions of the invention described herein.

In one embodiment, the invention may include methods for technician-enabled on-site electronic distribution of software products. In one embodiment, prior to technician-enabled on-site electronic distribution of software products, a reseller and a technician may be registered with the electronic distribution system.

In one embodiment, the reseller may apply for registration to the electronic distribution system. In one embodiment, applying for registration to the electronic distribution system may include the reseller providing the vendor with certain “reseller profile” information. In one embodiment, the reseller may provide the reseller profile information to the vendor by visiting a portal to the electronic distribution system such as, for example, a reseller registration website. Upon visiting the reseller registration website, a business owner or other person affiliated with the reseller may enter the reseller profile information into one or more forms provided by the graphical user interface of the reseller registration website. The reseller profile information may be used to create and store a “reseller profile.” In one embodiment, the reseller may also accept vendor-imposed terms and conditions for resellers operating under the on-site electronic distribution model

In one embodiment, the vendor may decide whether to approve or reject the reseller's application for registration to the electronic distribution system. If the vendor accepts the reseller's application, the vendor and the reseller may agree on a payment arrangement by which the reseller compensates the vendor for software products distributed to end-users. In some embodiments, the reseller establishes a line of credit with the vendor (or a third-party operating on behalf of, or otherwise in association with, the vendor), wherein the reseller can incur debts to the line of credit up to a certain amount over a certain period of time by distributing software products via the electronic distribution system. In another embodiment, the reseller provides the vendor with a credit card account number, wherein the vendor charges the credit card account for each software product distributed to end-users via the electronic distribution system. Other methods for conducting financial transactions between the vendor and the reseller may be used.

In one embodiment, the reseller may be enrolled in an automatic incentive program that automatically pays the reseller a certain amount of money for each software product distributed to end-users via the electronic distribution system.

In one embodiment, a registered reseller may receive a confirmation communication regarding registration with the electronic distribution system. In one embodiment, the confirmation communication may include an email that includes registration information regarding the reseller such as, for example, a reseller identification number and/or a password for accessing the portals and/or other parts of the electronic distribution system.

In one embodiment, one or more technicians may be invited to register with the electronic distribution system. In these embodiments, an invited technician may receive an invitation communication that includes, for example, the reseller identification number of a reseller who is sending the invitation, a web address (e.g., a uniform resource locator [URL]) of a portal such as, for example, a technician registration website, or other information necessary for the technician to register with the electronic distribution system as an affiliate of the reseller who is sending the invitation.

In one embodiment, invited technicians may then apply for registration with the electronic distribution system as an affiliate of the reseller by whom they were invited. In one embodiment, this application for registration may include the technician providing the electronic distribution system with technician profile information. The technician profile information provided by the technician may be stored in a database associated with the electronic distribution system and may be used to create a “technician profile.”

If the vendor approves the technician for registration to the electronic distribution system, a confirmation communication may be sent to the technician and the reseller who invited the technician. The technician confirmation communication may include certain information such as, for example, a technician identification number for use in accessing the electronic distribution system, a password for use in accessing the electronic distribution system, and/or other information.

After the reseller and at least one technician associated with the reseller have been registered with the electronic distribution system, the technician is able to begin distribution of the vendor's software products using the on-site electronic distribution model.

In one embodiment, the technician may participate in an on-site visit with an end-user. In some embodiments, the technician may initially participate in the on-site interaction with the end-user for purposes other than distributing software products via the electronic distribution system. For example, the technician may be employed by a reseller who otherwise operates an on-site computer repair/sales/installation business or other business. The technician may otherwise be scheduled for an on-site visit to the end-user's home to diagnose and/or repair a problem with the end-user's personal computer. The technician participating in an on-site visit may utilize the on-site interaction with the end-user as an opportunity to distribute software to the end-users via the electronic distribution system.

In one embodiment, the technician may utilize the end-user's computer system to access the electronic distribution system via a network (e.g., the Internet). For example, the technician may operate the end-user's computer system and accesses a portal provided by the electronic distribution system such as, for example, an on-site technician website. The on-site technician website may be specifically designed for navigation and use by technicians, as opposed to navigation and use by end-users. The technician may login to the on-site technician website by entering his or her technician identification number and/or password.

Once the technician is granted access to the electronic distribution system, the technician may utilize a diagnostic scanner stored on/provided by the electronic distribution system to perform a diagnostic scan of the end-user's computer system. In one embodiment, the diagnostic scanner may comprise a comprehensive software module (or group of individual modules) that scans the end-user computer system for currently installed software products (or the lack thereof) designed to solve computer-related problems such as, for example, computer performance, viruses or other malware, computer privacy, computer pests, parental controls, firewall protection, or other computer-related problems. In one embodiment, the diagnostic scanner identifies the brand/type of any software currently installed on the end-user's computer system that purportedly addresses any of the above-mentioned computer-related problems. The diagnostic scanner also identifies the date of installation of the software, and any updates thereto, and/or other information.

If necessary, the diagnostic scanner may recommend one or more software products that may remedy any deficient protection levels on the end-user's computer system. The one or more recommended software products may be available via the electronic distribution system.

In one embodiment, the technician may negotiate with the end-user regarding the sale of the recommended software products to the end-user. In one embodiment, this negotiation may include payment or pricing terms regarding the end-user's payment to the technician and/or the reseller for the software product. In some embodiments, these price/payment terms may be entirely determined/negotiated by the reseller, the technician, and/or a purchasing end-user, without input from the vendor. For example, the reseller may choose to offer one or more of the recommended software products bundled with other products or services already provided, or to be provided later. In this example, the reseller and the technician may be free from any pricing terms imposed by the vendor. In other embodiments, the pricing/payment terms regarding the one or more software products may be guided by vendor-suggested terms or may be mandated by vendor-specified terms.

The negotiation may lead to an agreement for the immediate purchase of one or more of the recommended software products. The technician may then initiate a download of the one or more agreed-upon software products from the electronic distribution system to the end-user's computer system.

The technician may then establish or re-establish a connection between the end-user's computer system and the electronic distribution system via a network. In some embodiments, the connection between the end-user's computer system and the electronic distribution system used to perform the diagnostic scan may still be active. Thus, no new connection may be needed. The technician may access the electronic distribution system via the on-site technician website. In one embodiment, the on-site technician website may include an “eStore” that provides a graphical user interface for the sale of software products to end-users.

The technician may use the eStore's graphical user interface to select from a menu of vendor-provided software products available for download via the electronic distribution system. The technician may select the agreed-upon software products and download a copy of each agreed-upon software product to the end-user's computer system. The technician may then install and configure each of the one or more downloaded software products on the end-user's computer system. This configuration/installation may include acquiring license key from the on-site technician website or other portal to the electronic distribution system.

The electronic distribution system may keep transaction records of all of the software products downloaded to the end-user's computer system. These transaction records may be used to charge the account of the reseller associated with the installing technician for each software product distributed to the end-user in the transaction. Agreements between the reseller and the vendor govern this charge, while the above-mentioned negotiation between the technician and the end-user governs the transaction as it relates to the reseller, the technician, and the end-user.

In one embodiment, incentive payments may be made from the vendor to reseller and/or the technician for each software product distributed by the technician. In one embodiment, the vendor may deposit incentive payments into a credit, debit, or other account of the reseller or technician that has been established for the receipt of such incentive payments.

These and other objects, features, and advantages of the invention will be apparent through the detailed description of the preferred embodiments and the drawings attached hereto. It is also to be understood that both the foregoing summary and the following detailed description are exemplary and not restrictive of the scope of the invention.

### BRIEF DESCRIPTION OF THE DRAWINGS

FIG. 1 illustrates an example of an on-site electronic distribution model, according to an embodiment of the invention.

FIG. 2 illustrates an example of an on-site electronic distribution model, according to an embodiment of the invention.

FIG. 3 illustrates an example of a process wherein resellers and technicians are registered to an electronic distribution system, according to an embodiment of the invention.

FIG. 4 illustrates an example of a process wherein a technician my distribute one or more software products to an end-user via an electronic distribution system.

FIG. 5 illustrates an example of a diagnostic report, according to an embodiment of the invention.

FIG. 6 illustrates an example of an express checkout interface, according to an embodiment of the invention.

FIG. 7 illustrates an example of a product registration interface, according to an embodiment of the invention.

FIG. 8 illustrates an example of an order confirmation interface, according to an embodiment of the invention.

FIG. 9 illustrates an example of a transaction report, according to an embodiment of the invention.

FIG. 10 illustrates an example of a transaction report, according to an embodiment of the invention.

FIG. 11 illustrates an example of a transaction report, according to an embodiment of the invention.

FIG. 12 illustrates an example of a transaction report, according to an embodiment of the invention.

### DETAILED DESCRIPTION

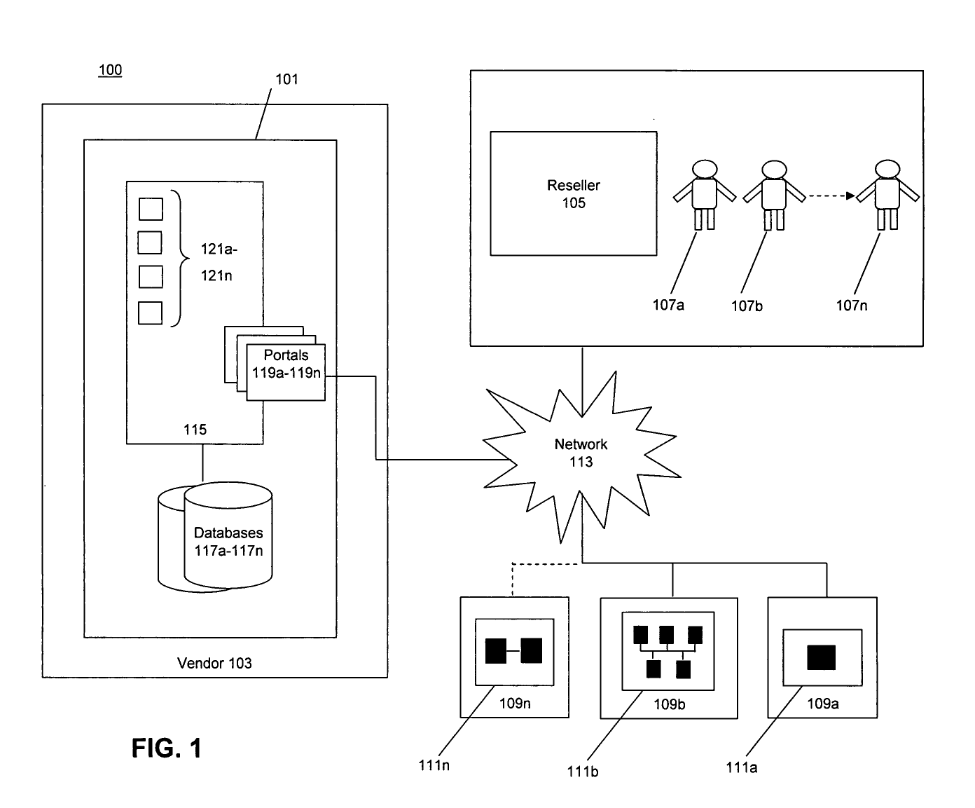

The invention provides a system and method for electronic distribution of software products via a technician-enabled on-site electronic distribution model. FIG. 1 illustrates an on-site electronic distribution model 100 whereby one or more software products may be distributed to an end-user via a technician-enabled electronic software distribution system (hereinafter “electronic distribution system”). On-site electronic distribution model 100 includes an electronic distribution system 101, a vendor 103, a reseller 105, one or more technicians 107a-107n, one or more end-users 109a-109n (each end-user having an end-user computer system 111a-111n), a network 113, and other elements.

In one embodiment, electronic distribution system 101 may include a vendor computer system 115. Vendor computer system 115 may comprise one or more servers, desktop computers, laptop computers, or other machines with memory and processing capability necessary to store and/or distribute one or more software products, provide access to electronic distribution system 101, or provide other features or functions of the invention.

Electronic distribution system 101 may be operated or supported by vendor 103. In one embodiment, vendor 103 may include an organization that produces, develops, or otherwise procures software products and distributes those products for ultimate use by one or more end-users 109a-109n. In one embodiment, part or all of electronic distribution system 101, including vendor computer system 115, may be operated or supported by a third party on behalf of or in association with vendor 103.

Onsite-electronic distribution model 100 may also include one or more resellers 105 (FIG. 1 illustrates one reseller 105, multiple resellers may be included). A reseller 105 may include a corporation, partnership, sole proprietorship, or other business organization, entity, or individual that agrees to distribute vendor 103's software products via electronic distribution system 101 using technicians 107. In some embodiments, reseller 105 may also engage in other business. For example, reseller 105 may engage in on-site computer installation/repair for individuals or businesses. Once reseller 105 registers with electronic distribution system 101, reseller 105 may utilize on-site interaction with customers as opportunities for distribution of vendor 103's software products via electronic distribution system 101.

In one embodiment, a reseller 105 may be associated with one or more computers (e.g., personal computers or other computers [not illustrated]) that are used to interact with electronic distribution system 101. For example, as detailed below, reseller 105 may utilize its associated computer(s) to access a portal of electronic distribution system 101 (e.g., a registration website) and register with electronic distribution system 101. Reseller 105 may otherwise interact with electronic distribution system 101 via its associated computers for other purposes.

In one embodiment, reseller 105 may be associated with one or more technicians 107. In one embodiment, the one or more technicians 107 may be employees of reseller 105, independent contractors to reseller 105, or otherwise be associated with reseller 105. For example, reseller 105 may have multiple employees, some of which are trained computer technicians that travel to a customer's place of business to perform a service and/or sell one or more products. Reseller 105 may utilize these trained computer technicians as technicians 107 to distribute vendor 103's software products via electronic distribution system 101.

In one embodiment, technicians 107 may be associated with one or more computers (e.g., personal computers or other computers [not illustrated]). In some instances, these computers may be used to interact with electronic distribution system 101. However, as detailed below, during on-site visits With end-users 109, a technician 107 may interact with electronic distribution system 101 using computer systems 111 of end-users 109. During other interactions with electronic distribution system 101 (e.g., registration, viewing profile or sales information, or other interaction), technicians 107 may utilize their associated computers.

On-site electronic distribution model 100 may include one or more end-users 109. In one embodiment, end-users 109a-109n may include one or more individuals, a household, a small, medium, or large business organization, a non-profit organization, an educational organization, a religious institution, or other types of end-users.

Each of end-users 109a-109n may include an end-user computer system 111. End-user computer system 111 may include one or more computers and other computer-related equipment such as, for example, one or more servers, desktop computers, laptops, personal digital assistants, handheld computing devices (e.g., Blackberry™ devices), mobile phones, pagers, computer networks, network-related equipment (e.g., routers), or other equipment.

For example, in one instance, an end-user 109 may comprise an individual. This individual's computer system 111 may comprise a single desktop computer. In another instance, an end-user 109 may include a household. This household's computer system 111 may comprise multiple computers (e.g., two desktop computers and a laptop). In yet another instance, an end-user 109 may include a small business. This small business' computer system 111 may comprise a computer network having one or more servers, multiple desktop computers, multiple laptop computers, multiple handheld computing devices, multiple cell phones, and/or other elements. Other types of end-users 109 may exist having computer systems 111 comprising other components.

In one embodiment, on-site electronic distribution model 100 may include network 113. Network 113 may enable communication and data transfer between the component parts of on-site electronic distribution model 100. For example, network 113 may enable communication and data transfer between some or all of electronic distribution system 101, vendor 103, reseller 105 (via its associated computer(s)), technicians 107a-107n (via his or her associated computer), end-users 109a-109 (via their end-user computer systems 111), end-user computer systems 111 themselves, and/or other parts of on-site electronic distribution model 100.

In one embodiment, network 113 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), and/or other network. Any suitable communications link may be utilized to connect components of on-site electronic distribution model 100 to network 113, including any one or more of, for instance, a copper telephone line, a Digital Subscriber Line (DSL) connection, a Digital Data Service (DDS) connection, an Ethernet connection, an Integrated Services Digital Network (ISDN) line, an analog modem connection, a cable modem connection, a wireless connection, or other connection.

In one embodiment, electronic distribution system 101 may include one or more databases 117a-117n, which may be operatively connected to vendor computer system 115. Databases 117a-117n may be, include, or interface to, for example, an Oracle™ relational database sold commercially by Oracle Corporation. Other databases, such as Informix™, DB2 (Database 2) or other data storage or query formats, platforms, or resources such as OLAP (On Line Analytical Processing), SQL (Standard Language Query), a SAN (storage area network), Microsoft Access™ or others may also be used, incorporated, or accessed into the invention. Databases 117a-117n may include any combination of databases or other data storage devices.

In one embodiment, electronic distribution system 101 may also include one or more portals 119a-119n. Portals 119a-119n may provide resellers, technicians, administrators, or other users with access to electronic distribution system 101. In one embodiment, one or more of portals 119a-119n may comprise one or more websites supported by vendor computer system 115 or other parts of electronic distribution system 101. These one or more websites may provide graphical user interfaces (GUIs) enabling parties operating within on-site electronic distribution model 100 to perform activities according to the features and functions of the invention described herein.

In one embodiment, the one or more websites or other portals 119a-119n may be operated/supported by vendor 103. In other embodiments, the one or more websites or portals 119a-119n may be operated/supported by a third party on behalf of, or in association with, vendor 103.

The one or more websites or other portals 119a-119n may include, for example, a reseller registration website that enables a reseller 105 to apply for registration or otherwise register with electronic distribution system 101 and a technician registration website that enables a technician 107 to apply for registration or otherwise register with electronic distribution system 101.

In one embodiment, the one or more websites or other portals 119a-119n may also include, for example, an on-site technician website that enables a technician 107 to access electronic distribution system 101 during an on-site visit with an end-user for the purposes of performing diagnostic scans, promoting software products, downloading software products to the end-user's computer system 111, configuring software products on the end-user's computer system 111, or other access. In one embodiment, the on-site technician website may include an electronic store or “eStore” that provides a technician 107 with details and features of software products available via electronic distribution system 101 and enables the technician 107 to download those software products to the end-user's computer system 111.

In one embodiment, the one or more websites or other portals 119a-119n may also include, for example, a reseller “command center” website. The reseller command center may provide a reseller 105 with a business management tool regarding the portion of the reseller's business related to distribution of vendor software products via electronic distribution system 101. The reseller command center may enable a reseller 105 to access and/or edit reseller profile information, access and/or edit technician profile information for technicians 107 associated with the reseller, access transaction records regarding software distributed by a reseller's associated technicians 107, access incentive payment information or tax information related to distributed software products or paid incentives, or access/edit/update other information.

In one embodiment, the one or more websites or other portals 119a-119n may also include, for example, a technician “command center” website. The technician command center may enable a technician 107 to view reseller profile information regarding the reseller associated with the technician, access and/or edit their technician profile information, access transaction records regarding software they have distributed, access incentive payment information or tax information related to distributed software products or paid incentives, or access/edit/update other information.

The technician command center or other portal supported by electronic distribution center 101 may also include a training center wherein technicians 107 receive training or other information regarding electronic distribution system 101. This may include training regarding the features of various products distributed via electronic distribution system 101, use of a diagnostic scanner to scan end-user computer systems 111, sales pitches for distributing software products, downloading of software products to end-user computer systems 111, installing/configuring downloaded software products, or other training. In one embodiment, the technician command center may provide access to or otherwise include the on-site technician website or eStore.

In one embodiment, the one or more websites or other portals 119a-119n may also include, for example, administrative portals for vendor 103 and/or any associated third parties operating in association with vendor 103. For example, vendor 103 or third party associated with vendor 103 may utilize the administrative portals to monitor/receive transaction records regarding distributed software or provide incentive payments to reseller 105. Other administrative portals may also exist.

In one embodiment, the one or more portals 119a-119n may enable information broadcasts from electronic distribution system 101 to reseller 105 and/or technicians 107. For example, information broadcasts may include notifications regarding new products, new virus threats, spyware outbreaks, new incentives, sales programs, or other information. Information broadcasts may be sent via email or attachments thereto, traditional mail, fax communication, text messaging, instant messaging, telephone communication, or other form of communication.

In one embodiment, electronic distribution system 101 may also include one or more modules 121a-121n. Modules 121a-121n may include one or more software modules that enable electronic distribution system 101 to receive and store reseller profile information, make decisions regarding whether to accept a reseller 105 for registration to electronic distribution system 101, register a reseller with electronic distribution system 101, notify a reseller 105 of non-acceptance of registration to electronic distribution system 101, enroll a reseller 105 into an incentive program, send a confirmation communication and/or welcome kit to a registered reseller 105, enable resellers 105 to invite one or more technicians 107 to apply for registration to electronic distribution system 101, send registration invitations to one or more technicians 107, receive and store technician profile information, make decisions regarding whether to accept a technician 107 for registration to electronic distribution system 101, notify a technician 107 that an application for registration with electronic distribution system 101 has been rejected, register a technician 107 with electronic distribution system 101, send a confirmation communication and/or welcome kit to a technician 107, provide one or more portals 119 for access to electronic distribution system 101, load a diagnostic scanner onto an end-user computer system 111, perform a diagnostic scan of an end-user computer system 111, generate a diagnostic report, recommend one or more software products for an end-user computer system 111, download one or more software products from electronic distribution system 101 to an end-user computer system 111, aid in the installation or configuration of one or more software products onto an end-user computer system 111, provide one or more license keys to a technician 107 and/or an end-user 109, create and save an installation record for downloaded/distributed software products, create one or more transaction reports regarding downloaded software products, charge a reseller's account for downloaded/distributed software products, carry out other financial transactions related to the distribution of software products, provide incentive payments to a reseller 105 or a technician 107, or perform other features or functions of the invention.

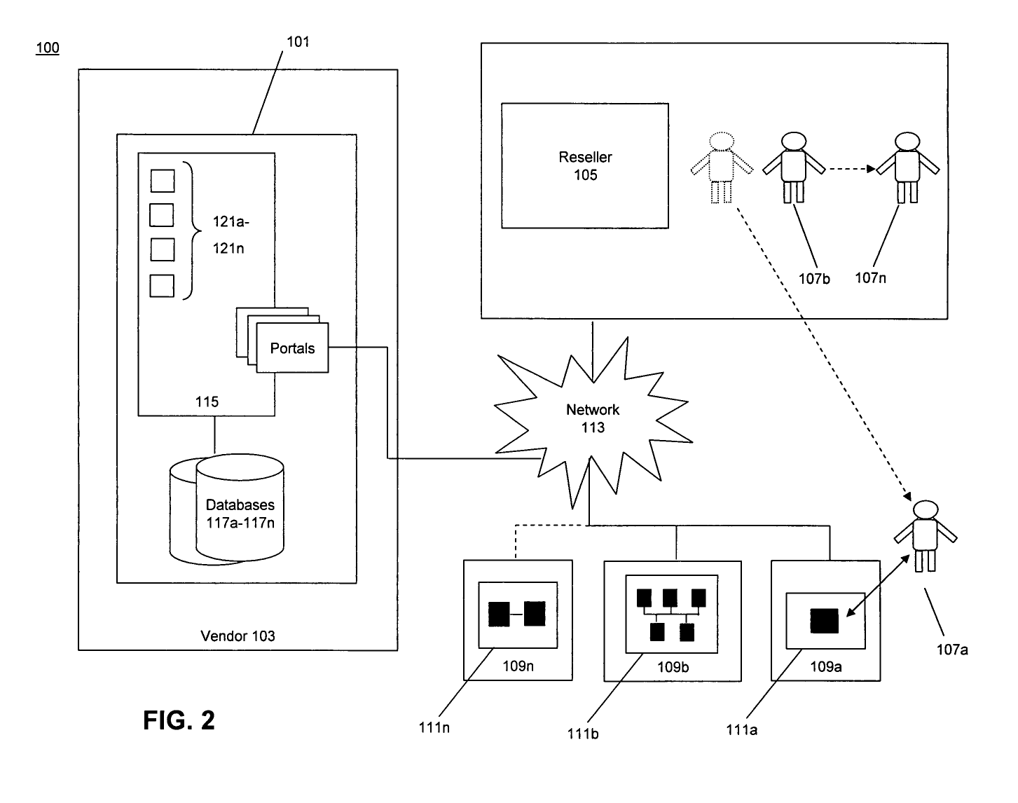

As mentioned herein, electronic distribution system 101 may be utilized to distribute software products to one or more end-users 109 via on-site interaction between end-users 109 and technicians 107. FIG. 2 illustrates on-site electronic distribution model 100 wherein a technician 107a is interacting with an end-user 109a and the end-user's computer system 111. As detailed below, technicians 107-107n may provide completely inventory-less distribution of vendor 103's software products to one or more end-users 109a-109n via on-site interaction using electronic distribution system 101.

Those having skill in the art will appreciate that the invention described herein may work with various system configurations. Accordingly, more or less of the aforementioned system components may be used and/or combined in various embodiments. It should also be understood that one or more of software modules 121a-121n may be maintained on vendor computer system 115 and/or other components of electronic distribution system 101, as necessary. In other embodiments, as would be appreciated, the functionalities described herein may be implemented in various combinations of hardware and/or firmware, in addition to, or instead of, software.

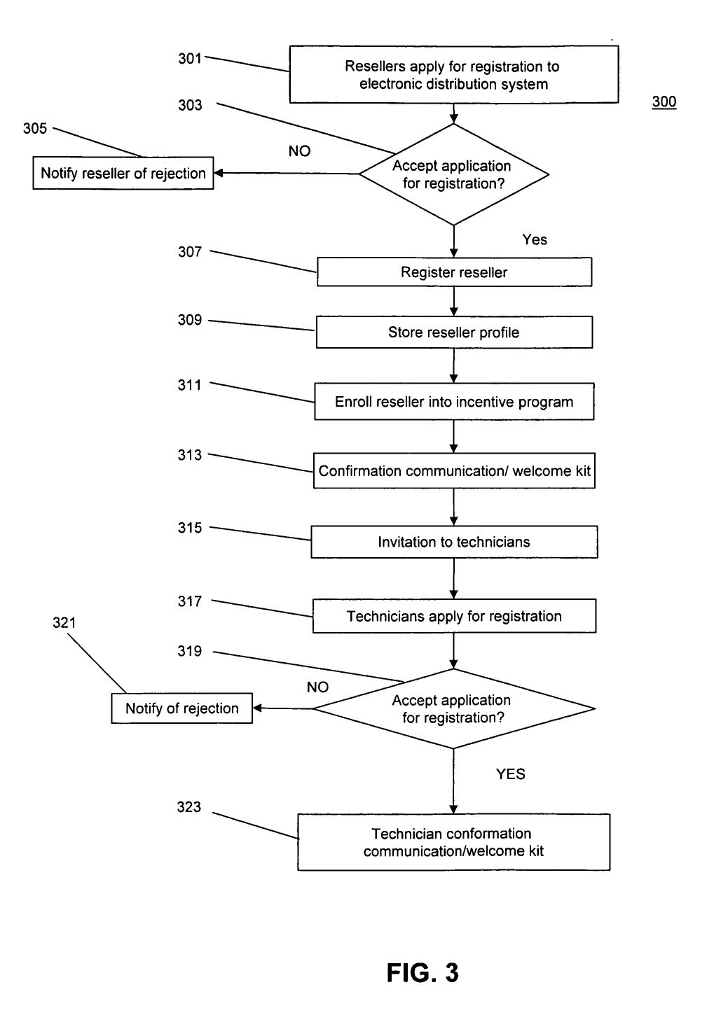

In one embodiment, the invention may include methods for technician-enabled on-site electronic distribution of software products. In one embodiment, prior to technician-enabled on-site electronic distribution of software products, one or more resellers 105 and technicians 107 may be registered to electronic distribution system 101. FIG. 3 illustrates a process 300, wherein one or more resellers 105 and technicians 107 may be registered with electronic distribution system 101.

Process 300 includes an operation 301 wherein a reseller 105 may apply for registration to electronic distribution system 101. As mentioned above, in some embodiments, electronic distribution system 101 may be operated, hosted, or supported by vendor 103. In other embodiments, part or all of electronic distribution system 101 may be operated, hosted, or supported by a third party for the benefit of, or in association with, vendor 103.

In one embodiment, reseller 105 may be invited to apply for registration to electronic distribution system 101. In other embodiments, reseller 105 may apply for registration to electronic distribution system 101 on their own initiative, in response to a general advertisement, or for other reasons.

In one embodiment, applying for registration to electronic distribution system 101 may include reseller 105 providing vendor 103 with certain “reseller profile” information such as, for example, identification information regarding reseller 105 (e.g., reseller's business name), location information regarding reseller (e.g., where is reseller 105 based, where does reseller 105 do business), any state or local business registration/certification regarding reseller 105, information regarding the ownership or management of reseller 105 (e.g., names of business owners, managers, or affiliates), information regarding the employees of reseller 105 (including any technicians 107 employed by or affiliated with reseller 105), financial information regarding reseller 105 (e.g., credit history of business entities and/or business owners), and/or other information.

In one embodiment, business owner(s) of reseller 105 may provide their social security numbers to electronic distribution system 101 as reseller profile information. The social security numbers may be used for many purposes such as, for example, identification purposes, credit history checks, or other purposes. In some embodiments, depending on the organizational structure of a reseller 105, the social security numbers of reseller 105's business owners may be used to account for incentive payments as income (e.g., 1099 income) for the business owners, or may be used for other tax purposes.

In some embodiments, a reseller 105 may provide a promotional code along with reseller profile information. In one example, the promotional code may have been received by reseller 105 in an invitation to register with on-site electronic distribution model 101 or general advertisement regarding registration with electronic distribution system 101. The promotional code may serve to provide reseller 105 with certain incentives or discounts as part of reseller 105's relationship with vendor 103. For example, a reseller 105 or technician 107 may typically pay an application fee in order to apply for registration to electronic distribution system 101. In some embodiments, the promotional code may provide a partial or full waiver of the application fee. In some embodiments, the promotional code may also enable vendor 103 to track the success of certain invitations or advertisements (e.g., promotions) or may be used for other purposes.

In some instances, state, provincial, or other governmental entities may license reseller or retailers for tax purposes. In some instances, these licensed resellers do not pay sales taxes or other taxes normally charged by the governmental entities when purchasing inventory for resale (sales tax being ultimately paid by end-users). In some instances these government-licensed resellers are provided with a reseller certificate. The reseller certificate may inform suppliers that the reseller is a licensed reseller and thus does not need to pay sales tax or other tax on purchases of inventory.

Accordingly, in one embodiment, when applying for registration, reseller 105 may provide vendor 103 with a reseller certificate for one or more states in which reseller 105 is a licensed reseller. Reseller 105 may first indicate that they are a licensed reseller by, for example, checking a box on a registration form or website. Reseller 105 may then provide vendor 103 with a copy of the reseller certificate via email attachment, fax, traditional mail, or other communication methods.

In one embodiment, reseller certificates submitted by resellers 105 may be reviewed and approved or rejected by a vendor 103 or a third party affiliate of vendor 103 prior to registering a reseller 105. In one embodiment, vendor 103 or the third party affiliate may maintain a queue of reseller profile information. A reseller's profile information is held in the queue until its corresponding reseller certificate is approved or rejected.

In some embodiments, resellers 105 whose reseller certificates have not yet been approved may be registered and permitted to distribute software products via an unlicensed reseller portal 119 (e.g., a “tax” eStore), wherein resellers 105 pay sales tax for each distributed software product. Upon approval of the resellers certificate, approved resellers may then be permitted to transact via a licensed reseller portal 119 (e.g., a “non-tax” eStore), wherein sales tax is not paid by the resellers for distributed software products.

In one embodiment, licensed resellers 105 are not charged sales tax or other applicable tax on software distributed by their technicians 107, as long as the software is distributed in the state, province, or other locality where reseller is licensed. Otherwise, resellers are charged sales tax or other applicable tax on software distributed to end-users 109 by technicians 107. As mentioned above, electronic distribution system 101 may provide separate on-site websites/portals 119 (e.g., separate eStores) for access by technicians 107 who are associated with licensed resellers and those who are associated with unlicensed resellers. Accordingly, sales tax is charged to unlicensed resellers 105 whose technicians 107 distribute software via the unlicensed reseller portal (e.g., the “tax” eStore), and sales tax is not charged to licensed resellers whose technicians 107 distributed software via the licensed reseller portal (e.g., the “non tax” eStore).

In one embodiment, a reseller 105 may provide reseller profile information to vendor 103 by visiting a reseller registration website. In one embodiment, this registration website may be a portal 119 to electronic distribution system 101. Upon visiting the reseller registration website, a business owner or other person affiliated with reseller 105 may enter the reseller profile information into one or more forms provided by the graphical user interface of the reseller registration website. The reseller profile information may be used to create and store a “reseller profile.”

In one embodiment, reseller 105 may accept vendor-imposed terms and conditions for resellers 105 operating under on-site electronic distribution model 100 during application for registration. In some embodiments, reseller 105 may vary one or more terms or conditions of registration to electronic distribution system 101 or may propose one or more alternate or additional terms or conditions.

In one embodiment, the reseller registration website or other portal 119 of electronic distribution system 101 may include links to one or more websites enabling resellers 105 to obtain reseller certificates. For example, the reseller registration website may include links to a plurality of state-sponsored or otherwise official websites for licensing resellers in one or more localities.

In one embodiment, the reseller registration website may be operated and maintained by vendor 103. In other embodiments, the registration website may be operated by a third-party for the benefit of, or in association with, vendor 103.

Other communication methods may be used for reseller 105 to apply for registration. For example, reseller 105 may fill out a paper form soliciting reseller profile information. The paper form may be sent to vendor 103 via a specified communication method such as, for example, in an attachment to an email, via fax machine, via traditional mail, or via other methods. Alternative paperless methods of communication may also be used to provide reseller profile information such as, for example, telephone, instant messaging, text messaging, email, or other methods.

The “reseller profile” created using the reseller profile information may be used for many purposes within an on-site electronic software distribution model. For example, ownership information regarding reseller 105 may be used to investigate the history of reseller 105 and its ownership. The reseller profile may be used for other purposes such as, for example, registering approved resellers 105 with electronic distribution system 101, inviting and registering technicians 107 with electronic distribution system 101, associating technicians 107 with a specific reseller 105, tracking and accounting for software products distributed by technicians 107, providing incentives to reseller 105 for software products distributed, keeping tax records regarding distributed software products, provided incentives, or for other purposes.

In one embodiment, in an operation 303, vendor 103 may decide whether to approve or reject reseller 105's application for registration to electronic distribution system 101. This decision may take into account the credit history of the reseller or its business owners, other business history of the reseller or its business owners, the market in which the reseller proposes to operate, and/or may take into account other factors.

If, in operation 303, vendor 103 decides to reject a reseller's application to register with electronic distribution system 101, vendor 103 (or a third-party) may notify reseller 105 to that effect in an operation 305.

If, in operation 303, vendor 103 accepts reseller's application, reseller 105 is registered with electronic distribution system 103 and notified to that effect in an operation 307. In some embodiments, to register a reseller 105 with electronic distribution system 101, vendor 103 and reseller 105 must agree on a payment arrangement by which reseller 105 compensates vendor 103 for the software products that reseller 105 distributes to end-users 109a-109n.

For example, in some embodiments, reseller 105 can be registered as a “platinum member” within electronic distribution system 101. As part of the platinum membership, reseller 105 establishes a line of credit with vendor 103 (or a third-party associated with vendor 103), wherein reseller 105 can incur debts to the line of credit up to a certain amount over a certain period of time by distributing software products via electronic distribution system 101.

In another example, reseller 105 can be registered as a “gold member” within electronic distribution system 101. As part of the “gold membership,” reseller 105 may provide vendor 103 (or a third-party associated with vendor 103) with a credit card account number, wherein vendor 103 will charge the credit card account of reseller 105 for each software product distributed to end-users via electronic distribution system 101. Other membership levels and/or methods for conducting financial transactions between vendor 103 and resellers 105 may be used.

In one embodiment, a third party that is associated with vendor 103 may issue lines of credit to resellers 105 registered with electronic distribution system 101 on behalf of, or for the benefit of, vendor 103. In some embodiments, the third party may be better equipped to extend credit to resellers 103 than vendors 103. In other embodiments, vendor 103 may extend lines of credit to resellers 105. Regardless of what party extends a line of credit to resellers 105, resellers 105 may, in some embodiments, submit credit applications that are first reviewed by vendor 103 or associated third-parties prior to lines of credit being extended to resellers 105.

If reseller 105 is registered with electronic distribution system 101 in an operation 307, reseller 103's reseller profile may be stored in a database (e.g., a database 117) associated with electronic distribution system 101 in an operation 309.

In an operation 311, reseller 105 may be enrolled in an automatic incentive program. For example, information from reseller 105's reseller profile may be used to enroll reseller 105 into a special program incentive fund (SPIF) that automatically pays reseller 105 a certain amount of money for each software product distributed to end-users 109 via electronic distribution system 101. Other incentive schemes may be used.

In some embodiments, the incentive program may be administered by a third-party incentive program administrator associated with vendor 103. For example, in one embodiment, transaction records may be kept regarding software products distributed by technicians 107. In one embodiment, vendor 103 or the third-party incentive program administrator may establish an incentive payment account for reseller 105. In some embodiments, the incentive payment account may include a credit/debit account. In some embodiments, the incentive-payment account may be separate from the accounts/line of credit utilized by reseller 105 to pay vendor 103 for distributed software products. In other embodiments, the account used for payment of incentives to reseller 105 may be the same as the account used for payments to vendor 103 for distributed software products. Other methods of providing incentive payments may also be used.

The transaction records of distributed software products may be transmitted to vendor 107 or the third-party incentive program administrator, who analyzes the transaction records and automatically credits the reseller incentive payment account according to an incentive scheme previously agreed upon by vendor 103 and reseller 105. In one example of an incentive scheme, incentive payments may be deposited into the incentive payment account of a reseller 105 every time a technician 107 associated with the reseller 105 successfully distributes a software product to an end-user 109. Other incentive schemes may be used.

In an operation 313, an approved reseller 105 may receive a confirmation communication regarding registration with electronic distribution system 101. In one embodiment, the confirmation communication may include an email that is sent to an email address associated with reseller 105. In other embodiments, the confirmation communication may include other forms of communication with reseller 105 such as, for example, traditional mail, fax communication, text messaging, instant messaging, telephone communication, or other form of communication. The confirmation communication may include registration information regarding reseller 105 such as, for example, a reseller identification number and/or a password for accessing portals 119a-119n, databases 117a-117n, and/or other parts of electronic distribution system 101. In some embodiments, the confirmation communication may also include other information.

It should be noted that wherever an “identification number” is described herein (e.g., reseller identification number, technician identification number, order identification number, or other identification number), the identification number may comprise all numbers, all letters, a mix of numbers and letter, or other string of alphanumeric indicators. Therefore, identification numbers are not limited to strings of numbers.

In one embodiment, after reseller 105 is registered with electronic distribution system 101, the reseller may also receive a welcome kit. In one embodiment, the confirmation communication may be included in the welcome kit. In other embodiments, the confirmation communication may be designed to be received by reseller 105 immediately (e.g., via email), while the welcome kit may be received at a later time.

In an operation 315, one or more technicians 107 may be invited to register with electronic distribution system 101. In one embodiment, each reseller 105 may employ or otherwise be associated with one or more computer technicians 107. In other embodiments, reseller 105 itself may be a technician 107. In some embodiments, reseller 105 may have to separately register as a technician 107 through the process described herein. In other embodiments, the reseller/technician may be automatically registered as a technician 107 by virtue of indicating the dual role of reseller/technician during reseller registration.

In on-site electronic distribution model 100, technicians 107 participate in on-site interaction with end-users 109. For example, a technician 107 may be solicited by an end-user 109 to diagnose and/or repair a problem with the end-user's computer system 111. The technician 107 may then make an on-site “house call” to perform this service. This on-site interaction with end-users 109 provides opportunities for distribution of software products via electronic distribution system 101, as is discussed in detail below.

In one embodiment, a business owner or other authorized person associated with reseller 105 may send invitations to one or more technicians 107 that are desired to participate in on-site electronic software distribution model 100. In one embodiment, this may involve the business owner sending invitation communications to one or more technicians 107. These invitation communications may include the reseller identification number of the reseller 105 sending the invitation, a web address (e.g., a uniform resource locator [URL]) to the technician registration website or other portal 119, or other information necessary for a technician 107 to register with electronic distribution system 101 as an affiliate of the reseller 105 sending the invitation. The invitation communication or other invitation-related information may be sent to technicians 107 via email or attachment thereto, traditional mail, fax communications, text messaging, instant messaging, telephone communications, or other forms of communication.

In one embodiment, vendor 103 or a third party affiliate of vendor 103 may send invitations to technicians 107. For example, reseller 105 may provide vendor 103 with information regarding technicians 107 that the reseller wishes to participate in on-site electronic software distribution model 100. Vendor 103 may then send an invitation communication as described above to the designated technicians 107.

In some embodiments, reseller 105 may send out invitations to technicians 107 (or designate technicians 107 to whom invitations are to be sent) during reseller registration (e.g. operation 301). In another embodiment, reseller 105 may send invitations after reseller 105 has been registered to electronic distribution system 101. In other embodiments, invitations to register with electronic distribution system 101 at other times.

In an operation 317, invited technicians 107 may then apply for registration with electronic distribution system 101 as an affiliate of the reseller 105 by whom they were invited. In one embodiment, this application for registration may include technician 107 providing technician profile information such as, for example, identification information, location information, financial information, or other information to vendor 103.

In one embodiment, technician profile information may include a technician 107's social security number. The technician's social security number may be used for identification purposes, for credit checks, for background checks, or for other purposes. In one embodiment, a technician 107's social security number may be used to account for incentive payments as income (e.g., 1099 income) or for other tax purposes.

In one example, technician 107 may receive an invitation communication that includes an reseller identification number and a URL for the technician registration website/portal 119. In one embodiment, the technician registration website may be the same as, similar to, or part of the reseller registration website used to register resellers 105. Technician 107 may visit the technician registration website and enter in the provided reseller identification number, along with the technician profile information required for an application for registration. Other methods of providing technician-profile information to the vendor may also be used such as, for example, email, traditional mail, fax communication, text message, instant messaging, telephone communication, or other methods. The technician-profile information provided by technician 107 may be stored in a database (e.g., database 117) associated with electronic distribution system 101 and may be used to create a “technician profile.”

The technician profile may be used by vendor 103 or a third party associated with vendor 103 for multiple purposes such as, for example, determining whether to register a technician 107, tracking software products distributed by technician 107, charging a reseller 105 affiliated with technician 107 for software products distributed by technician 107, providing incentives to reseller 105 and/or technician 107, or for other purposes.

In an operation 319, the information entered by technician 107 may be used to determine whether technician 107 is accepted for registration to electronic distribution system 101. For example, the personal information entered by technician 107 may indicate that technician 107 has a criminal record or other background information such that vendor 103 does not wish to do business with technician 107. In some embodiments, there may be no approval process and all technicians 107 to whom invitations were sent may be eligible to register simply by providing the necessary technician-profile information to vendor 103.

If, in operation 319, the vendor does not approve a technician 107 for registration to electronic distribution system 101, the technician 107 and/or the reseller 105 who invited technician 107 may receive notification to that effect in an operation 321.

If, in operation 319, vendor 103 approves a technician 107 or the technician 107 is otherwise enabled to register with electronic distribution system 101, a technician confirmation communication may be sent in an operation 323. The technician confirmation communication may be sent to the approved technician 107 and/or to reseller 105 associated with technician 107. In one embodiment, the technician confirmation communication may include certain registration information such as, for example, a technician identification number for use in accessing electronic distribution system 101 (this may be the same as or different from the reseller identification number provided to the reseller 105 with whom technician 107 is associated), a password for use in accessing electronic distribution system 101, and/or other information.

This technician confirmation communication may be distributed to technician 107 and/or the associated reseller 105 via email, traditional mail, fax communication, text messaging, instant messaging, telephone communication, or other method. In some embodiments, the technician confirmation communication may be part of or be accompanied by a welcome kit that is sent to technician 107. In other embodiments, a welcome kit may be sent to technician 107 separately.

In some embodiments, a reseller 105 associated with one or more registered technicians 107 may be able to selectively activate or deactivate the associated technicians 107. For example, if the relationship between a reseller 105 and a technician 107 is terminated (e.g., the reseller fires the technician), the reseller 105 may deactivate the technician's registration with electronic distribution system 101 so that the technician 107 cannot distribute software via electronic distribution system 101. In some embodiments, the technician 107 may then register as an associate of another reseller 105.

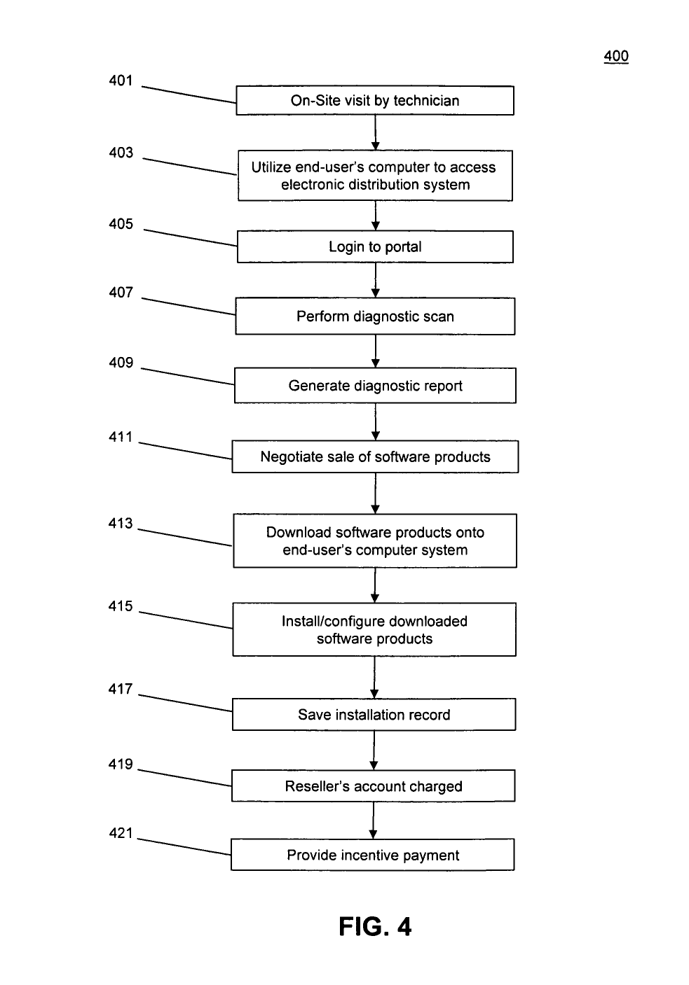

After reseller 105 and one or more technicians 107 associated with reseller 105 have been registered with electronic distribution system 101, as in process 300, a technician 107 is able to begin distribution of the vendor's software products. FIG. 4 illustrates a process 400, wherein a technician 107 associated with a reseller 105 distributes one or more software products provided by a vendor 103 to an end-user 109 via electronic distribution system 101.

In an operation 401, technician 107 may participate in an on-site visit with an end-user 109 that is related to the end-user's computer system 111. In some embodiments, technician 107 may initially participate in the on-site interaction with end-user 109 for purposes other than distributing software products via electronic distribution system 101. For example, technician 107 may be employed by reseller 105 who otherwise operates an on-site computer repair/sales/installation business (or other business), such as, for example, Geeks On Call™, Nerds On Site™ or other on-site computer service business. If end-user 109 is an individual person and end-user computer system 111 is a single personal computer, technician 107 may otherwise be scheduled for an on-site visit to end-user 109's home to diagnose and/or repair a problem with end-user 109's personal computer.

In another example, if end-user 109 is a small business and the end-user's computer system 111 includes a network of multiple computers, technician 107 may otherwise be scheduled for an on-site visit to an office of the small business to install a new computer on the small business' computer network or to remedy a problem with the network. Other examples of end-users 109 having different end-user computer systems 111 and/or other reasons for technician on-site interaction may exist.

In any event, the technician 107 participating in an on-site visit may utilize the on-site interaction with end-users 109 as an opportunity to distribute software to end-users 109 via electronic distribution system 101. In some embodiments, on-site interaction between a technician 107 and an end-user 109 need not be initiated for a purpose other than software distribution via electronic distribution system. For example, the on-site visit may be wholly for the purposes of distributing software products via electronic distribution system 101.

In an operation 403, technician 107 may utilize the end-user's computer system 111 to access electronic distribution system 101 via a network 113 (e.g., the Internet). For example, if technician 107 is visiting an end-user's home, technician 107 may operate the end-user's computer system 111 and accesses a portal 119 to electronic distribution system 101. As technician 101 is accessing portal 119 through the end-user's computer system 111, rather than utilizing a computer system technician 107 has brought with him or her to end-user 109, the on-site electronic software distribution model provides an inventory-less technician enabled system. Therefore, technician 107 needs no tools, software, or other equipment to distribute vendor 103's software products to an end-user 109 during an on-site visit. All the tools needed by technician 107 are provided by electronic distribution system 101 via the one or more portals 119a-119n and access to electronic distribution system 101 is provided by end-user computer system 111.

In one embodiment, the portal 119 that grants technician 107 access to electronic distribution system 101 may include an on-site technician website. This on-site technician website/portal 119 may be similar to or part of the reseller and technician registration websites mentioned above. The on-site technician website may be specifically designed for navigation and use by technicians 107, as opposed to navigation and use by end-users 109. In some embodiments, technician 107 may have previously received training or instruction to become familiar with navigation and use of the on-site technician website. As such, a technician 107, not an end-user 109, accesses electronic distribution system 101 via end-user 109's computer system 111.

In one embodiment, technician 107 may initially access a portal 119 to electronic distribution system 101 using a URL associated with the on-site technician website. In an operation 405, technician 107 may be greeted with a login screen provided by the graphical user interface of the on-site technician website. Technician 107 may then enter his or her technician identification number and/or password to the on-site technician website before he or she is granted access to electronic distribution system 101. This user identification number and/or password may be the same as those given to technician 107 upon registration with electronic distribution system 101 (see process 300).

In one embodiment, once technician 107 is granted access to electronic distribution system 101 via the on-site technician website, technician 109 may utilize the graphical user interface provided by the on-site technician website to access a diagnostic scanner stored on/provided by electronic distribution system 101. The diagnostic scanner may then be used to perform a diagnostic scan of the end-user's computer system 111 in an operation 407.

In one embodiment, technician 107 may download the diagnostic scanner from electronic distribution system 101 via network 113 to the end-user's computer system 111. Technician 107 may then execute or run the diagnostic scanner from the copy stored on the end-user's computer system 111. In another embodiment, technician 107 may run a diagnostic scan of the end-user's computer system 111 from a copy of the diagnostic scanner stored on electronic distribution system 101. In yet another embodiment, technician 107 may bring a copy of the diagnostic scanner to end-user 109 on a disk, flash drive, or other storage device. Technician 107 may then load this copy of the diagnostic scanner onto the end-user's computer system 111 and perform the diagnostic scan.

In one embodiment, the diagnostic scanner may comprise a comprehensive scanning module or group of individual modules (such as, for example, one or more of modules 121a-121n) that scan the end-user's computer system 111 for one or more potential deficiencies such as, for example, suboptimal performance (e.g., unnecessary files that clog hard drives, clutter registries and affect system settings that limit Internet and system performance), inadequate levels of virus protection (protection against viruses, worms, Trojan horses or other programs that can damage files, destroy the content of hard drives and infect other computers), inadequate levels of privacy protection (protection regarding, for example, information that PCs remember, such as, websites visited, cookies that may store personal information and files recently viewed or edited), inadequate levels of protection against computer “pests” (for example, spyware, adware, and other online pests that can steal personal information, display unwanted ads and diminish PC performance), appropriate parental controls, appropriate firewall protection (especially for end-users 109 that are businesses), or for other threats or deficiencies in an end-user 109's computer system 111.

In one embodiment, the diagnostic scanner scans the end-user computer system 111 for currently installed software products (or the lack thereof) designed to solve the above-noted deficiencies or other computer threats. For example, the diagnostic scanner will detect if any virus protection software is installed on end-user 5109's computer system 111. The diagnostic scanner identifies the brand/type of software installed, the date of installation and any updates, and/or other information.

In an operation 409, the diagnostic scanner may generate a diagnostic report providing the results of the scan. The diagnostic report may include information mentioned above regarding the programs installed on end-user 109's computer system 111 that combat one or more common computer threats (e.g., general performance, virus threats, privacy threats, spy ware threats, parental controls, firewall issues, or other threats) or the lack thereof.

The diagnostic report may also include an indicator regarding the “level of protection” currently residing on an end user computer system 111 as related to the above identified threats, or deficiencies. For example, a diagnostic report for an end-user computer system 111 that is a home computer system may include 5 separately defined categories of protection: 1) general performance, 2) virus protection, 3) privacy threats, 4) spyware protection, and 5) parental controls. Other classifications/categories may be used, especially for different types of end-users 109 and/or different types of computer systems 111. For each of the defined categories of protection, the diagnostic report may provide “level of protection” according to a previously defined diagnostic report scheme.

In one embodiment, the diagnostic report scheme may include a color-coded scheme, whereby a color is associated with a level certain predefined level of protection. For example, green may be assigned to “fully protected;” yellow may be assigned to “inadequate protection detected;” and red may be assigned to “no protection detected.” Other colors and/or protection definitions, gradations thereof, and/or diagnostic report schemes may be used.

In one example, if the diagnostic scanner detects that an end-user computer system 111 includes an anti-virus program that is fully-updated and protects against all known viruses, the resultant diagnostic report may indicate that the end-user computer system 111 is “fully protected.” For example, in an embodiment utilizing a color-coded diagnostic report scheme, full protection may be indicated by displaying the words “fully protected” in a green box along with the details of the detected protection (e.g., the specific software product detected, the installation/update date, etc.). If, however, the diagnostic scanner detects an out of date or otherwise inadequate anti-virus software, the resultant diagnostic report may so indicate by displaying the words “inadequate protection detected” in a yellow box along with the details of the detected software (e.g., the specific software product detected, installation/update date, etc.). If the diagnostic scanner detects no anti-virus software, the resultant diagnostic report may so indicate by displaying the words “unprotected” in a red box. Other protection levels for other categories of protection may be displayed similarly. These instances are examples only, and protection levels for virus protection or other categories of protection may be reported differently according to different diagnostic report schemes.

In addition to providing an indicator of the level of protection currently on an end-user computer system 111, the diagnostic report may also include a recommendation of one or more software products that may be used to remedy any less-than-adequate protection levels. For example, if the diagnostic scanner indicates that the level of virus protection or other category of protection for an end-user computer system 111 is “inadequate protection detected,” “unprotected,” or other pejorative protection level, the report may include a recommendation of one or more software products available via electronic distribution system 101 that may remedy the apparent problems/lack of protection.

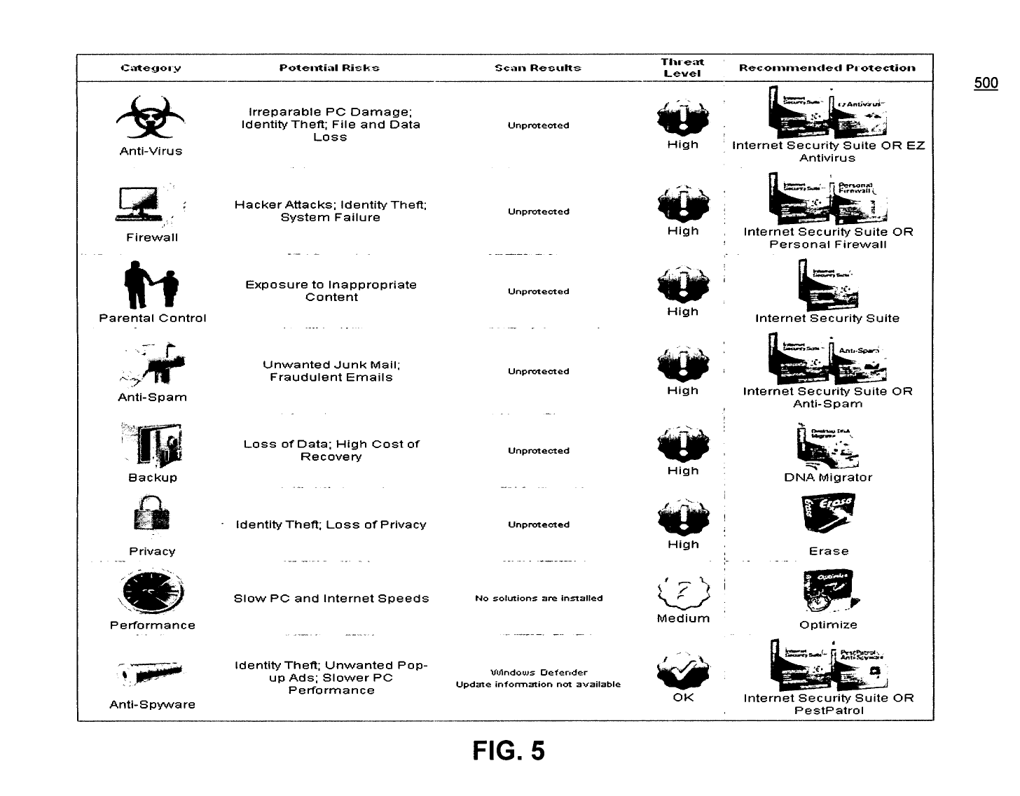

FIG. 5 illustrates a diagnostic report 500, which is an example of a diagnostic report according to an embodiment of the invention.

In some embodiments, the results of the diagnostic scanner (e.g., the diagnostic report) may be monitored/recorded by electronic distribution system 101 over network 113 for use in recordkeeping by technician 107, reseller 105, vendor 103, end-user 109, and/or by other parties. In some embodiments, the results of the diagnostic scanner may be stored in a database (e.g., one or more of database 117a-117n) associated with electronic distribution system 101. In some embodiments, multiple diagnostic reports may be saved and aggregated or otherwise considered together. For example, if a particular end-user computer system 111 includes multiple devices/computers, diagnostic reports may be generated for multiple devices/computers. These reports may then be used to compile data regarding part or all of the end-user computer system 111 and the collective needs thereof. In other embodiments wherein an end-user computer system 111 includes multiple devices/computers, the diagnostic scanner may produce a single diagnostic report for the entire system.

In some embodiments, technician 107 need not use the diagnostic scanner. In some embodiments, technician 107 may simply recommend one or more software products available via electronic distribution system 101 without system diagnosis. In some embodiments, an end-user 109 may request the purchase of, or information regarding, one or more of the software products available via electronic distribution system 101 of his or her own accord. As will be apparent to those of skill in the art, other scenarios whereby one or more software products available via electronic distribution system 101 are offered and installed on an end-user computer system 111 may occur.

In an operation 411, technician 107 may negotiate with end-user 109 regarding the sale of one or more software products available via electronic distribution system 101 to end-user 109. These software products may include those recommended on a diagnostic report produced by the diagnostic scanner or may include other products available through electronic distribution system 101. In one embodiment, this negotiation may include payment terms regarding end-user 109's payment to technician 107 and/or reseller 105 for the software product. In some embodiments, the payment terms may be entirely determined/negotiated by reseller 109, technician 107, and/or a purchasing end-user 109, without input from vendor 103. For example, reseller 105 may choose to offer one or more software products bundled with other products or services already provided, or to be provided later. In this example, reseller 105 may be free from any payment terms imposed by vendor 103. As such, the on-site technician website/portal 119 (e.g., eStore) may be free of any payment/pricing terms, so as not to influence negotiations between technician 107 and end-user 109.

In some embodiments, the pricing/payment terms regarding the one or more software products may be guided by vendor-suggested terms or may be mandated by vendor-specified terms. In some embodiments, end-users 109a-109n may receive rebates from one or more of vendor 103, reseller 105 or other parties for the purchase of one or more software products via electronic distribution system 101.

The negotiation in operation 411 may lead to an agreement for the purchase of one or more software products available via electronic distribution system 101. As mentioned above, these software products may include one or more of those recommended by the diagnostic report or may include other software products available via electronic distribution system 101. In one embodiment, the agreement may include installation of free trial versions of one or more software products. For example, an end-user 109 may agree to have a free trial of a software product (e.g., 30 day use of a software product) installed on his or her computer system 111, rather than purchase the full version of the software product.

In an operation 413, once technician 107 and end-user 109 have agreed on the installation of one or more software programs onto the end-user's computer system 111 (regardless of payment terms or other terms), technician 107 may initiate a download of the one or more agreed-upon software products from electronic distribution system 101 to end-user 109's computer system 111.

In one embodiment, end-user 109's computer system 111 may already have a connection open to electronic distribution system 101 via network 113, wherein technician 107 is already logged on to electronic distribution system 101. For example, if technician 107 had previously accessed electronic distribution system 101 using end-user computer system 111 (e.g., to perform a diagnostic scan, to access promotional materials regarding software products, or for other purposes), technician 107 may still be logged into an active session with electronic distribution system 101. However, in some instances, a previous session between the end-user's computer system 111 and electronic distribution system 101 may have been terminated for some reason (e.g., timed out, purposely ended, or otherwise terminated).

In instances wherein a previous connection has been disconnected, or in instances where no prior connection to electronic distribution system 101 was established, technician 107 may first establish a connection between end-user 109's computer system 111 and electronic distribution system 101 via network 113. As mentioned above, technician may establish this connection using a portal 119 provided by electronic distribution system 101. In one embodiment, portal 119 may include the on-site technician website discussed above or may include a separate website/portal 119. In one embodiment, this on-site technician website may include an “eStore” that provides a graphical user interface for the sale of software products to end-users 109.

To establish such assess to electronic distribution system 101, technician 107 may have to login to electronic distribution system 101 using the graphical user interface provided by the on-site technician website/eStore. In doing so, technician 107 may provide electronic distribution system 101 with his or her technician identification number, password, or other information, via the graphical user interface.

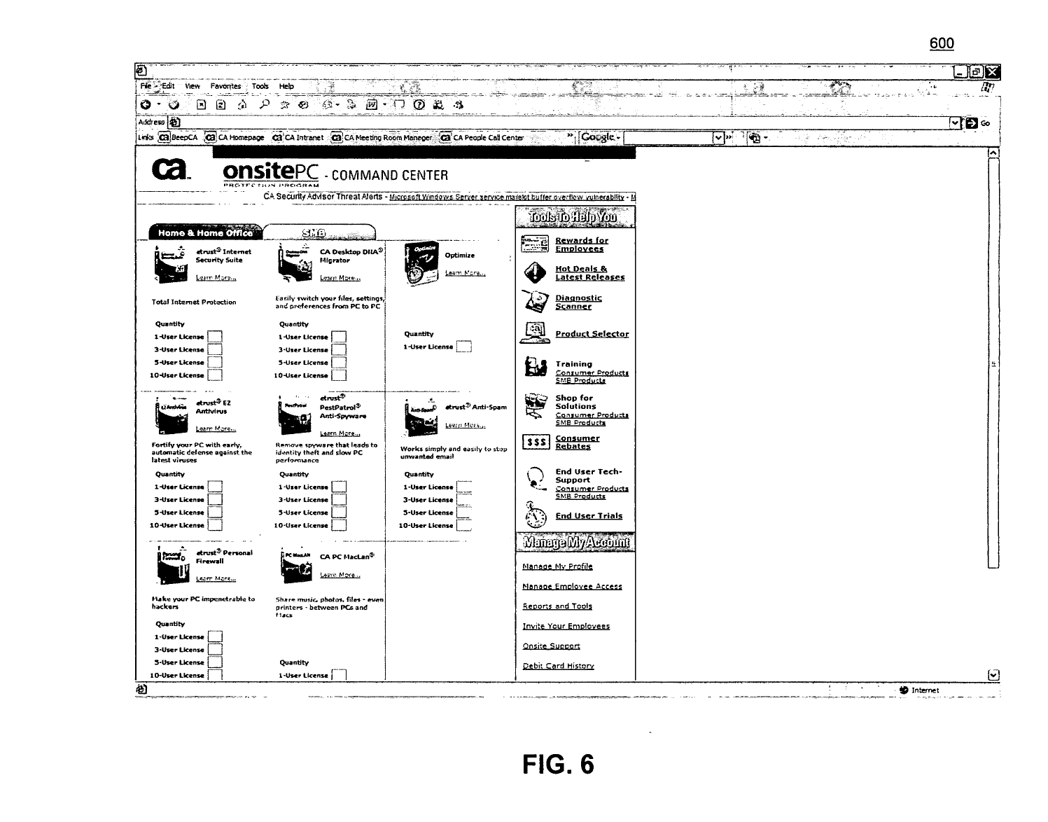

Once technician 107 is properly logged in to electronic distribution system 101, technician 107 may use the on-site technician website/eStore's graphical user interface to select from a menu of vendor-provided software products available for download via electronic distribution system 101. FIG. 6 illustrates an express checkout interface 600, which is an example of a graphical user interface provided by the on-site technician website, enabling technician 107 to select software products for download to end-user computer system 111. Technician 107 may select the agreed-upon software products and download a copy of each agreed-upon software product to end-user computer system 111.

As illustrated on the right side of FIG. 6, the on-site technician website may not only enable the selection of software products for purchase by end user 109, but may include various tools for use by technician including rewards or incentive information, hot deals, links to the diagnostic scanner, links to products available via electronic distribution system 101, technician training, consumer rebate information, technical support, information, trial software information, technician or reseller account management tools, or other tools.

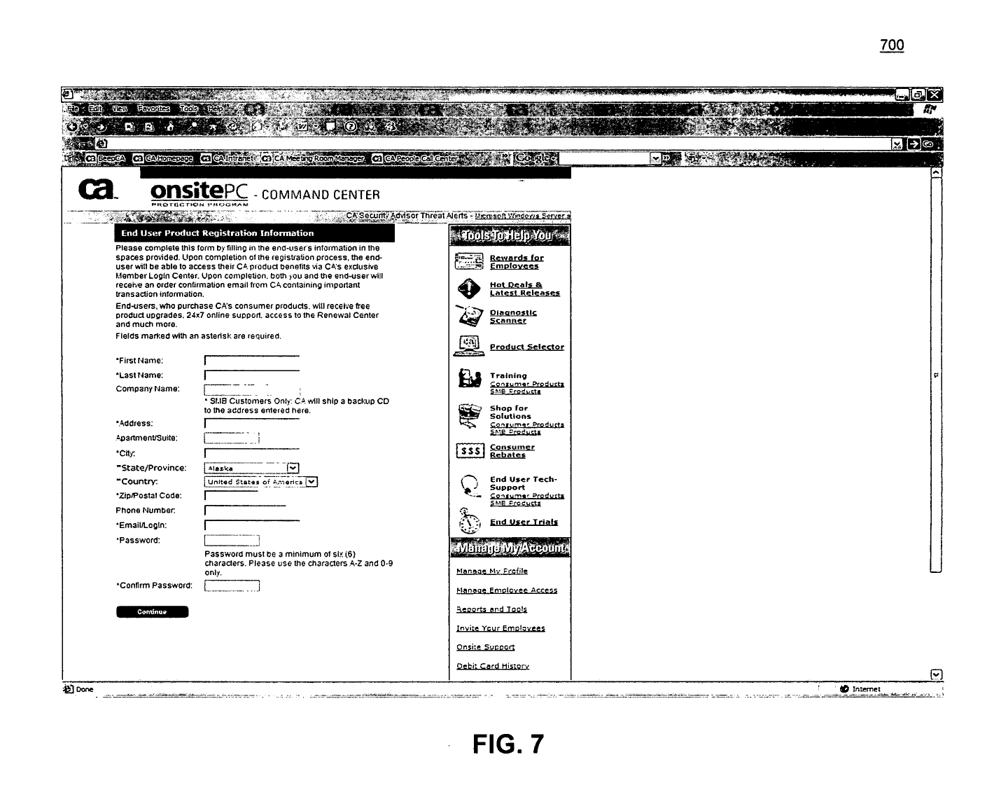

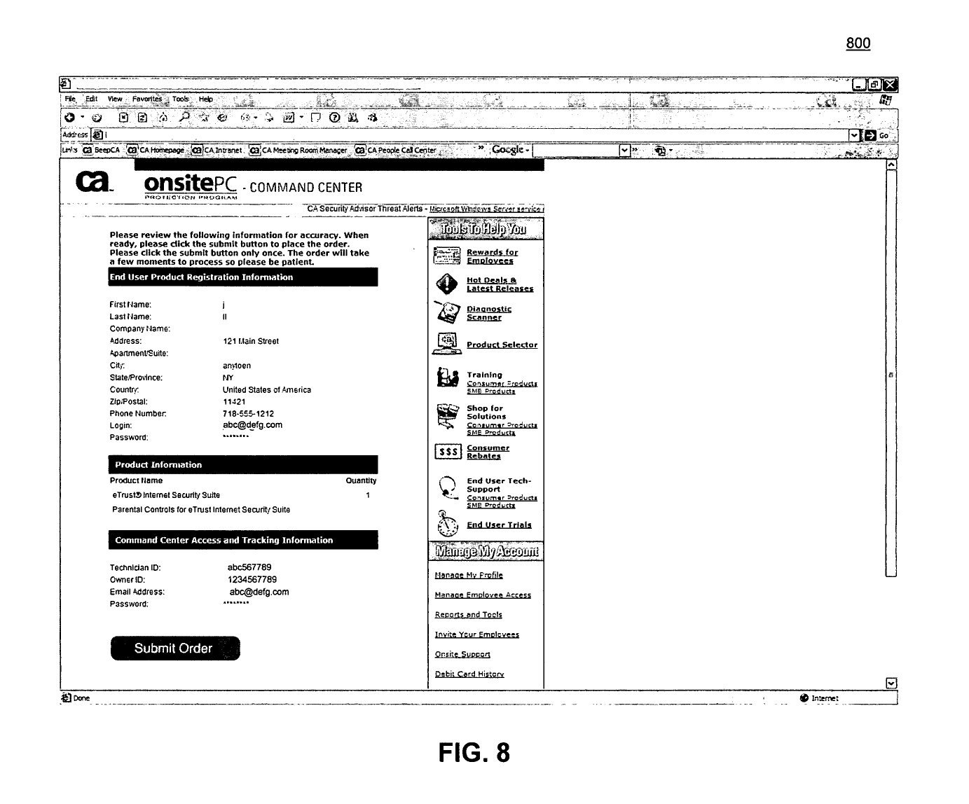

In an operation 415, technician 107 may then install and configure each of the one or more downloaded software products. In some embodiments, installation and configuration of downloaded software products may include “registering” the products, by providing end user 109's personal information in conjunction with the products. FIG. 7 illustrates a product registration interface 700, which is an example of a graphical user interface enabled by the on-site technician website, whereby technician 107 can enter in end-user 109's information to register downloaded products. FIG. 8 illustrates an order confirmation interface 800, which is an example of an interface enabled by the on-site technician website, whereby registration and/or order confirmation of software products may be displayed.

Software product distribution involves distribution of copies of the software products themselves. Additionally, purchase of a software product for use by an end-user typically involves the purchase of a license to use the software product. The description of the invention herein discusses the distribution of, purchase of, payment for, and/or other operations regarding software products. However, any discussion herein regarding the download, purchase, distribution, or other use of a software product by an end-user may also involve providing the end-user with the ability to legally make use of the software product for the end-user's benefit. This ability to make use of the software product may, in some embodiments, include providing the user with a license to use the software product (e.g., a “software license”). In one embodiment, a license may be provided to end user 109 after the downloaded products have been registered.

When software licenses are provided to end-users 109, an end-user 109 may also be provided with a license key (e.g., an alpha-numerical identification number) that enables an end-user 109 to make use of the software product. For example, in one embodiment, installation and/or configuration of a software product on a computer system may not be successfully completed until the license key for the software product is provided to an installation program.

In some embodiments, vendor 103 may maintain a bank of license keys for the software products distributed via electronic distribution system 101. In some embodiments, vendor 103 may maintain the bank of license keys in a database 117 of electronic distribution system 101 or in an associated system. In other embodiments, vendor 103 may provide the bank of license keys to a third party associated with vendor 103. The third party may then make the license keys available via electronic distribution system 101.

In one embodiment, electronic distribution system 101 may provide technician 107 with a license key for each of the one or more software products downloaded to an end-user computer system 111. In some embodiment, acquiring the license key may be considered part of the installation/configuration process of operation 415.

In one embodiment, technician 107 may access license keys via the on-site technician website or other portal 119. In other embodiments, the license key may be communicated to technician 107 via another method such as, for example, email, fax communication, instant message, text message, telephone communication, or other methods. In some embodiments, the one or more license keys may ultimately be provided to end-user 109 for future reference, re-installation, record keeping, product support, or for other purposes.

In one embodiment, separate license keys may be used for the installation of specific downloaded software products (i.e., each product may have its own license key). In another embodiment, a single license key may be used for a group of downloaded products (i.e., there may be a single key for multiple products).

In one embodiment, technician 107 may carry one or more copies of one or more software products with him or her to the on-site visit with end-user 109. For example, technician 107 may carry these software products on or more disks, flash drives, or other storage media. In these embodiments, technician 107 may download the agreed-upon software products to an end-user computer system 111 from the storage media and utilize electronic distribution system 101 to acquire the license keys for the downloaded software products or to otherwise activate/enable use of the downloaded software products.

In one embodiment, a backup copy of all software distributed to the end-user's computer system 111 via electronic distribution system 101 may be produced and shipped to end-user 109 upon completion of the end-user 109's transaction with technician 107.

In an operation 417, electronic distribution system 101 may keep an installation record of all of the software products downloaded to end-user computer systems 111. These installation records may be saved to a database (e.g., a database 117) associated with electronic distribution system 101 and may be used to produce one or more “transaction reports” as discussed below.

In one embodiment, these installation records may include the identity of each specific software product downloaded, a license key associated with each downloaded software product, the date and time of each download, the identity of the end-user 109 to which the software product was downloaded, the IP address or other network address of the end-user computer system 111, descriptive information regarding the end-user computer system 111 (e.g., what type of computer, how many computers on the system, or other information), the identity of the technician 107 performing the download, the identity of the reseller 105 affiliated with technician 107, and/or other information.

These installation records my be used for multiple purposes such as, for example, support or service regarding the downloaded product for end-users 109, maintenance of distribution records regarding technician 107 and/or reseller 105, and/or for other purposes. In one embodiment, distribution records for a technician107/reseller 105 may be used, for example, to monitor technician 107 or reseller 105's success (or lack thereof) in distributing software products via electronic distribution system 101, to track and provide incentives to technicians 107 or resellers 105, to record charges to reseller 105's account for the products distributed by the reseller's technicians 107, or for other purposes.

In one embodiment, installation records or other records associated with distribution of software via the on-site electronic distribution model may be used to produce “transaction reports.” These transaction reports may be used for the above mentioned record keeping or for other purposes and may be provided to one or more of vendors 103, resellers 105, technicians 107, end-user 109, administrators, third-parties associated with vendor 103, or other entities. These transaction reports may be sent to vendor 103, resellers 105, technicians 107 or other entities via one or more information broadcasts (e.g., email, traditional mail, fax, telephone) or may be accessible by vendor 103, reseller 105, technician 107, or other entity via one or more portals 119a-119n.

In some embodiments, different types of transaction reports may exist, each of which may include different information and/or may be directed towards different types of users (e.g., vendor 103, reseller 105, technician 107, end-user 109, or other user).

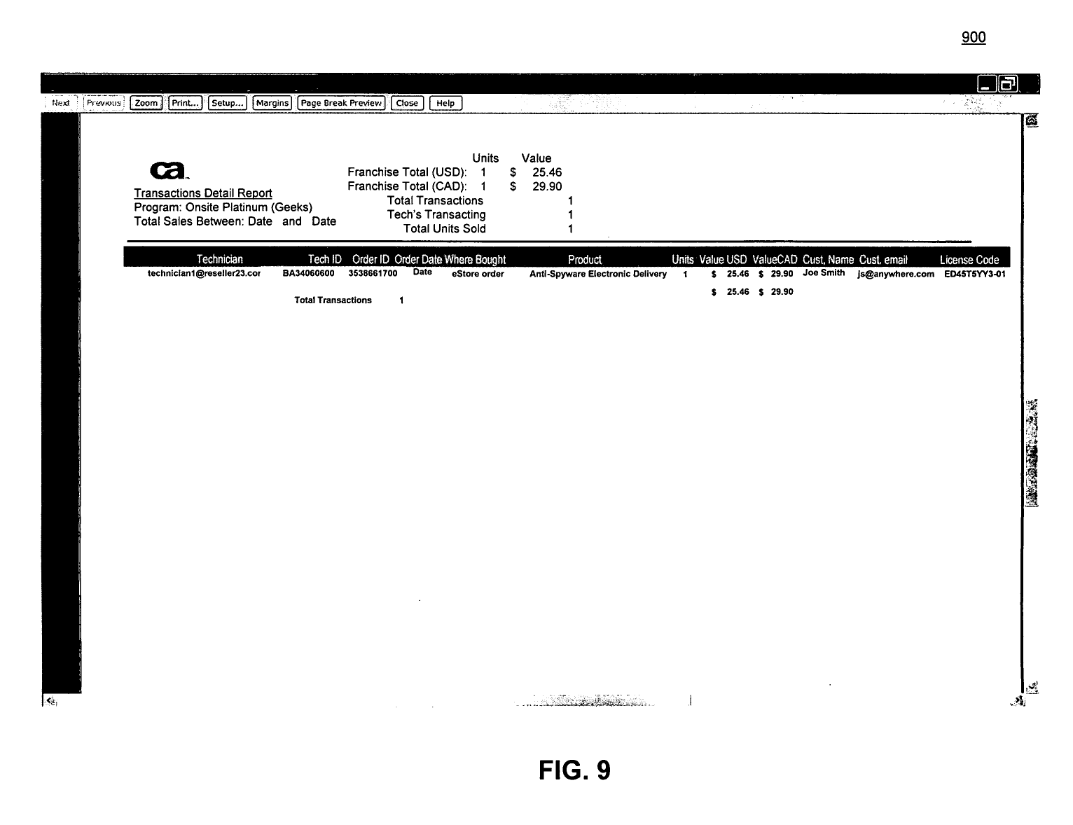

For example, in one embodiment, electronic distribution system 101 may produce a transaction report, such as, “transaction detail report” 900 illustrated in FIG. 9. Each transaction detail report 900 may list a single transaction and may be used to provide details to resellers 105 and technicians 107 as to where revenue is generated from. As used herein, a single “transaction” may include an instance wherein a technician 107 distributes one or more software products to an end-user 109 during an isolated on-site visit.

In one embodiment, transaction detail report 900 may be targeted to resellers 105 and technicians 107 and may include the following information: the name of the technician 107 who conducted the transaction, the technician identification number of the technician 107, an order identification number identifying the transaction, an order date that provides the date of the transaction, the name of the software product downloaded, the number of units involved in the transaction (for example, an end-user computer system 111 that includes multiple computers may require multiple units of the same software product), the value of the software products (e.g., in U.S. Dollars or other currency), the name of the end-user to whom the software product was distributed, the license key for the downloaded software product, or other information.

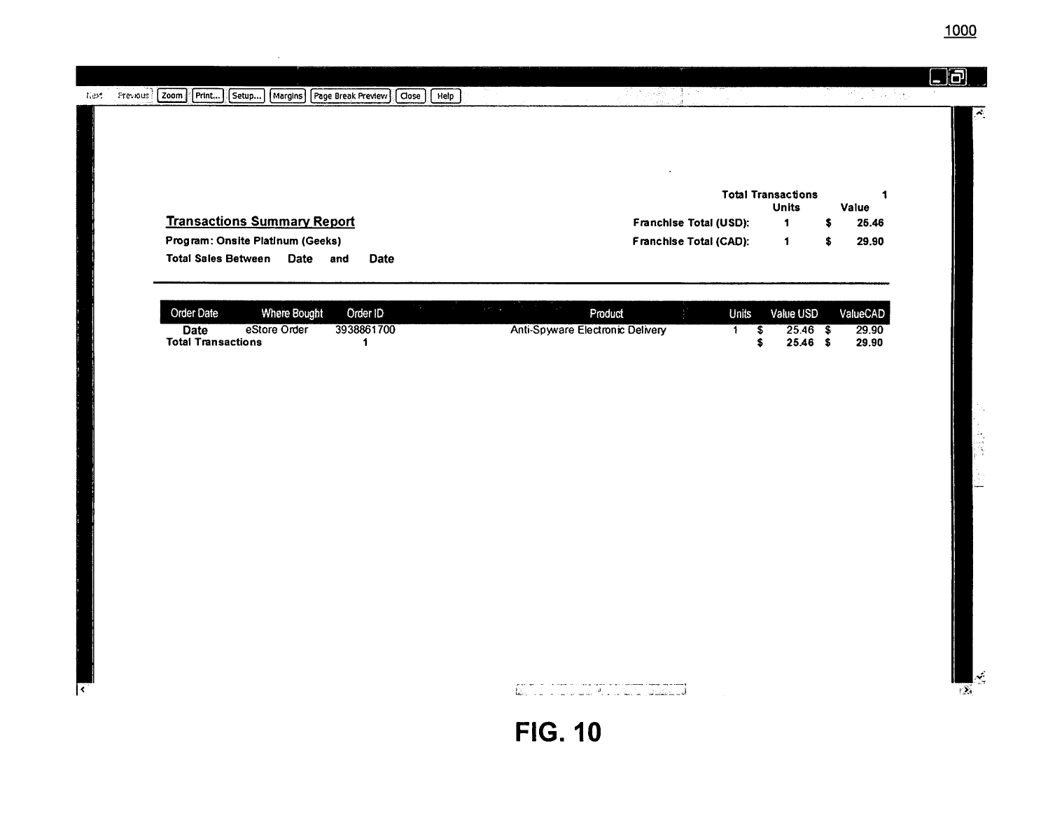

In one embodiment, electronic distribution system 101 may produce a transaction report such as, for example, “transaction summary report” 1000 illustrated in FIG. 10. Each transaction summary report 1000 may list a single transaction and may be used to provide details to resellers 105 and technicians 107 regarding sales data for each transaction. In one embodiment, transaction summary report 1000 may include the following information: an order date that provides the date of the transaction, an order identification number, the name of the software product downloaded, the number of units involved in the transaction, the value of the software products, or other information.

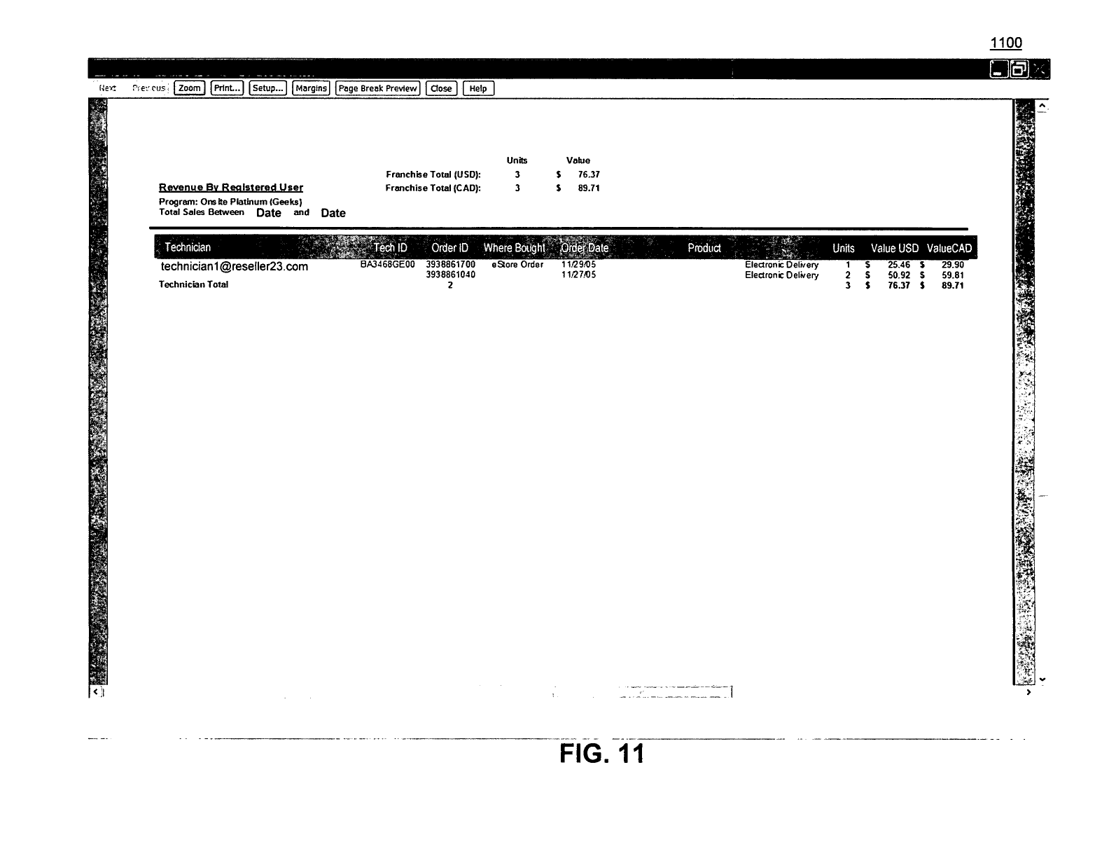

In one embodiment, electronic distribution system 101 may produce a transaction report such as, for example, “Revenue by Registered User Report” 1100 illustrated in FIG. 11. Revenue by registered user report 1100 may list revenue by technician 107 for a single transaction. In one embodiment, revenue by registered user report 1100 may be targeted for resellers 105 and may include the following information: the name of the technician 107 who conducted the transaction, the technician identification number of the technician 107, an order identification number, an order date that provides the date of the transaction, the name of the software product downloaded, the number of units for each software product involved in the transaction, the value of the software products, or other information.

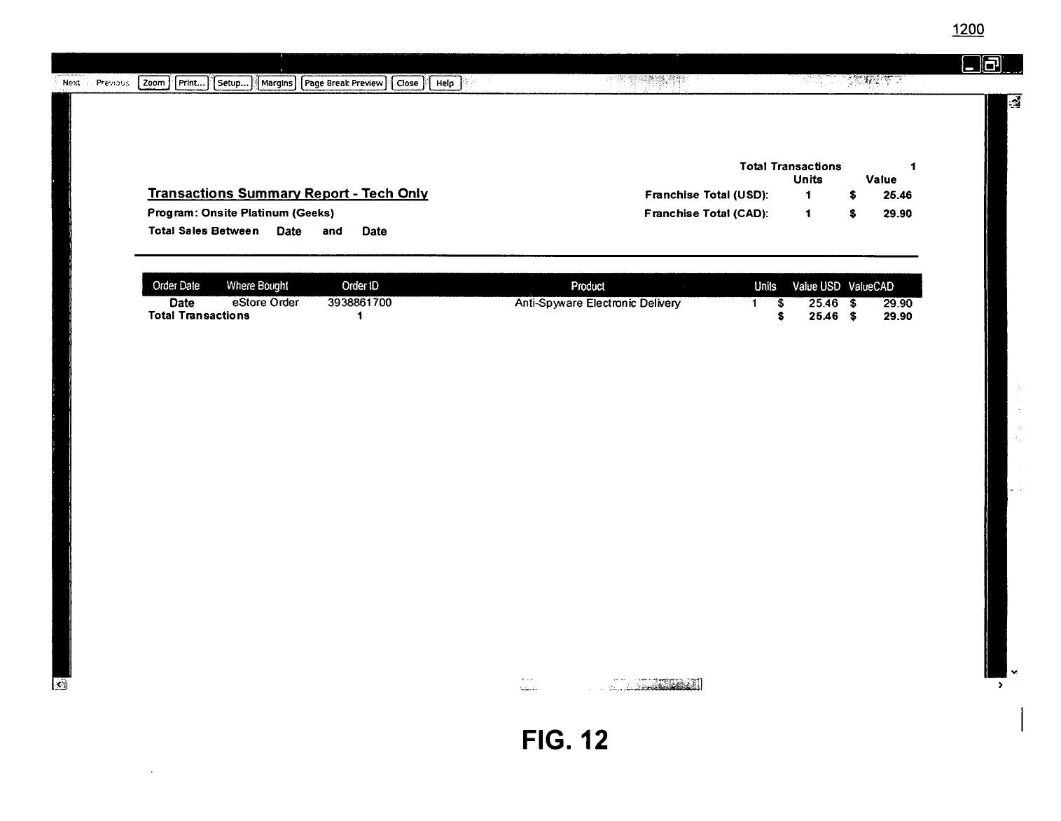

In one embodiment, electronic distribution system 101 may produce a transaction report such as, for example, “Technician Transaction Summary Report” 1200 illustrated in FIG. 12. Technician transaction summary report 1200 may supply sales data regarding a single transaction. In one embodiment, technician transaction summary report 1200 may be targeted to technicians 107 and may include the following information: an order date that provides the date of the transaction, an order identification number, the name of the software product downloaded, the number of units for each software product involved in the transaction, the value of the software products, the name of the end-user to whom the software product was distributed, the email address of the end-user to whom the software product was distributed, the license key for the downloaded software product, or other information.

In one embodiment, electronic distribution system 101 may produce a transaction report such as, for example, an “Internal Sales Report” (not illustrated). The internal sales report may track performance by each of resellers 105. In one embodiment, the internal sales report may be targeted to vendor 103 and may include the following information: the name of a reseller 105, the reseller identification number of the reseller 105, the location of the reseller 105, the level of membership of the reseller 105 (e.g., gold, platinum, or other membership level), the number of technicians 107 associated with the reseller 105, the number of end-user 109 transactions per associated technician 107 (this number may be broken down into individual end-users 109 and business end-users 109, The number of registered technicians 107 associated with the reseller 105, the number of technicians 107 associated with the reseller 105 that are actively transacting with end-users 109, the total number of software product units sold, the total value (e.g., in U.S. Dollars and/or other currency) of software products sold, the net revenue generated for vendor 103 by the reseller 105 (e.g., in U.S. dollars and/or other currency), or other information.

Other transaction reports having other fields may exist.

In an operation 419, the financial account of the reseller 105 associated with technician 107 who distributed the downloaded software products is charged for each software product distributed by technician 107 via electronic distribution system 101. Agreements between reseller 105 and vendor 103 govern the charge made in operation 419.

In one embodiment, resellers 105 and/or technicians 107 may receive invoice communications regarding software products distributed via electronic distribution system 101. These invoice communications may provide details regarding the financial accounts used for payments from reseller 105 to vendor 103. These accounts may include lines of credit established by vendor 103 or a third party associated with vendor 103 for resellers 105. In other embodiments, the accounts may include credit card accounts or other accounts by which resellers 105 pay vendors 103. In one embodiment, these invoice communications may also provide details regarding incentives provided to resellers 105 or technicians 107.

Invoice communications may take the form of emails or attachments thereto, traditional mail communications, fax communications, telephone communications, or other forms of communication. For example, in one embodiment, a reseller 105 may receive an email invoice (or an invoice in another communication format) each time a technician 107 associated with the reseller 105 distributes one or more pieces of software via electronic distribution system 101. In other embodiments, a reseller 105 may receive an email invoice (or invoice in another communication format) once a week (or other time interval) detailing all of the distributions of software products via electronic distribution system 101 by associated technicians 107. In one embodiment, technicians 107 may also receive invoice communications.

In an operation 421, incentive payments may be made from vendor 103 to reseller 105 according to an incentive agreement between vendor 103 and reseller 105. For example, vendor 103 and reseller 105 may agree that vendor 103 will pay reseller 105 a predetermined amount of money for each software product distributed by technicians 107 associated with reseller 105. Those having skill in the art may recognize that other incentive programs having different permutations may exist. In one embodiment, vendor 103 may deposit incentive payments into a credit, debit, or other account of reseller 105 that may be established for the receipt of such incentive payments. In some embodiments, incentive payments may also be made to technicians 107 by one or both of reseller 105 and vendor 103 for distribution of software products via electronic distribution system 101.

In one embodiment, end-users 109 may receive technical support for one or more software products downloaded to end-user computer systems 111 via electronic distribution system 101. In one embodiment, reseller 105 and/or technician 107 may provide technical support, which may include additional on-site visits with end-users 109.

In other embodiments, technical support may be provided by vendor 103. For example, an end-user 109 experiencing problems with a downloaded software product may contact vendor 103 (e.g., vie email, telephone, or other form of communication) and report the problems. In doing so, end-user 109 may provide vendor with the license key for the software product with which end-user 109 is experiencing problems. Vendor may then provide a responsive communication including support regarding the software product.

In some embodiments, technical support for software products downloaded via electronic distribution system 101, whether provided by vendor 103, reseller 105, or technician 107 may be provided for a fee additional to any fees paid for download and installation of the software products. In other embodiments, the cost of technical support may have been included in any fee paid for download and installation of software products.

In one embodiment, end-user's 109a-109n may be enabled to return one or more software products downloaded to end-user computer systems 111 for a refund. In some embodiments, incentives distributed to resellers 105 or technicians 107 for distributed software products may be reversed upon return of the software products by end-users 109a-109n.

While the invention has been described with reference to the certain illustrated embodiments, the words that have been used herein are words of description, rather than words of limitation. Changes may be made, within the purview of the associated claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the associated claims.

What is claimed is:

1. A method for distributing one or more software products of a software vendor to an end-user by a reseller, wherein the one or more software products are stored and distributed via an electronic distribution system, and wherein the software vendor provides the reseller with access to the electronic distribution system, the reseller employing a technician that makes on-site visits to the end-user, the method comprising:
providing a network portal to the electronic distribution system that is accessible to the technician via a computer network from a computer system of the end-user during an on-site visit by the technician to the end-user;
enabling the technician to download the one or more software products from the electronic distribution system to the computer system of the end-user via the computer network;
billing the reseller for the one or more software products downloaded to the computer system of the end-user; and
providing an incentive payment to one or more of the reseller or the technician for at least one of the one or more software products downloaded to the computer system of the end-user.

2. The method of claim 1, wherein the end-user provides payment to the reseller for the one or more software products downloaded to the computer system of the end-user.

3. The method of claim 1, wherein providing an incentive payment to one or more of the reseller or the technician further comprises establishing one or more incentive payment accounts for one or more of the reseller or the technician, the incentive payments being deposited into the one or more incentive payment accounts.

4. The method of claim 1, wherein billing the reseller for the one or more software products further comprises billing a line of credit of the reseller.

5. The method of claim 1, wherein billing the reseller for the one or more software products further comprises billing a credit card account of the reseller.

6. The method of claim 1 wherein enabling the technician to access the electronic distribution system further comprises providing a diagnostic scanning module that scans the computer system of the end-user for one or more potential deficiencies.

7. The method of claim 6, wherein the one or more potential deficiencies include one or more of inadequate performance, inadequate virus protection, inadequate privacy protection, inadequate spyware protection, and inadequate parental controls.

8. The method of claim 6, wherein providing a diagnostic scanning module further comprises enabling the technician to generate a diagnostic report regarding one or more actual deficiencies present on the computer system of the end-user.

9. The method of claim 8, wherein the diagnostic report recommends the one or more software products as a remedy for the one or more actual deficiencies.

10. The method of claim 1, wherein the on-site visit by the technician to the end user is initiated for purposes other than downloading the one or more software products to the computer system of the end-user.

11. A method for distributing one or more software products of a software vendor to an end-user by a reseller, wherein the one or more software products are stored and distributed via an electronic distribution system, and wherein the software vendor provides the reseller with access to the electronic distribution system, the reseller employing a technician that makes on-site visits to the end-user, the method comprising:
providing a network portal to the electronic distribution system that is accessible to the technician via a computer network from a computer system of the end-user during an on-site visit by the technician to the end-user, wherein the on-site visit by the technician to the end user is initiated for purposes other than downloading the one or more software products to the computer system of the end-user;
enabling the technician to download the one or more software products from the electronic distribution system to the computer system of the end-user via the computer network; and
billing the reseller for the one or more software products downloaded to the computer system of the end-user.

12. The method of claim 11, wherein the end-user provides payment to the reseller for the one or more software products downloaded to the computer system of the end-user.

13. The method of claim 11, further comprising providing an incentive payment to one or more of the reseller or the technician for at least one of the one or more software products downloaded to the computer system of the end-user.

14. The method of claim 13, wherein providing an incentive payment further comprises establishing one or more incentive payment accounts for one or more of the reseller or the technician, the incentive payments being deposited into the one or more incentive payment accounts.

15. The method of claim 11, wherein billing the reseller for the one or more software products further comprises billing a line of credit of the reseller.

16. The method of claim 11, wherein billing the reseller for the one or more software products further comprises billing a credit card account of the reseller.

17. The method of claim 1 wherein enabling the technician to access the electronic distribution system further comprises providing a diagnostic scanning module that scans the computer system of the end-user for one or more potential deficiencies.

18. The method of claim 17, wherein the one or more potential deficiencies include one or more of inadequate performance, inadequate virus protection, inadequate privacy protection, inadequate spyware protection, and inadequate parental controls.

19. The method of claim 17, wherein providing a diagnostic scanning module further comprises enabling the technician to generate a diagnostic report regarding one or more actual deficiencies present on the computer system of the end-user.

20. The method of claim 19, wherein the diagnostic report recommends the one or more software products as a remedy for the one or more actual deficiencies.
